(19) United States
(12) Patent Application Publication
(10) Pub. No.: US 2021/0388245 A1
(43) Pub. Date: Dec. 16, 2021

(54) CURABLE SEALANT COMPOSITIONS, SEAL CAP, AND METHODS OF MAKING AND USING THE SAME

(71) Applicant: 3M INNOVATIVE PROPERTIES COMPANY, St. Paul, MN (US)

(72) Inventors: William H. Moser, Edina, MN (US); Erik M. Townsend, South St. Paul, MN (US); Jonathan D. Zook, Stillwater, MN (US); Susan E. DeMoss, Stillwater, MN (US); Clinton J. Cook, Woodbury, MN (US); Michael D. Swan, Lake Elmo, MN (US)

(21) Appl. No.: 17/290,178

(22) PCT Filed: Oct. 29, 2019
(86) PCT No.: PCT/IB2019/059279

§ 371 Date: Apr. 29, 2021

Related U.S. Application Data
(60) Provisional application No. 62/758,220, filed on Nov. 9, 2018.

(51) Int. Cl. C09J 181/02; C08G 75/045; C09K 3/10

(52) U.S. Cl. CPC C09J 181/02; C09K 2003/1062; C09K 3/1012; C08G 75/045

(57) ABSTRACT

Curable sealant compositions comprise the components: a) x weight percent of at least one polythiol; b) y weight percent of at least one unsaturated compound having at least two non-aromatic carbon-carbon double bonds, at least one carbon-carbon triple bond, or a combination thereof; c) from 0.01 to 8 weight percent of at least one quaternary ammonium or phosphonium salt; d) from 0.05 to 10 weight percent of at least one organic peroxide; and e) optionally from 0.01 to 10 weight percent of a photoinitiator system capable of generating free radicals upon exposure to actinic radiation. Each of x and y represents a positive real number. The sum x+y is in the range of 72 to 99. The weight percent ranges of the components a)-e) are based on the total weight of the components a)-e). A seal cap including the curable sealant composition and methods of making and using the curable sealant compositions are also disclosed.

### TECHNICAL FIELD

The present disclosure broadly relates to thiol-ene sealant compositions and methods for their manufacture and use.

### BACKGROUND

The radical-mediated thiol-ene reaction is a very useful polymerization method for the generation of a variety of materials. The properties of these thiol-ene reactions which make them particularly attractive in an industrial setting include the relative insensitivity to the presence of oxygen and the typically low polymerization-induced shrinkage and shrinkage stress. As a result, radical-mediated thio-lene polymerizations have been utilized in the preparation of sealants, coatings, dental materials, and other related materials.

Radical-mediated thiol-ene polymerizations are most frequently initiated by photochemical and thermal methodologies. While these initiation methods have the advantages of spatial and temporal control over the curing, they may be inconvenient or inappropriate for many coating or sealant applications due to the need to transmit light in shadowed areas or through opaque samples, or due to the inability of materials to withstand necessary elevated temperatures.

Redox radical initiation systems can also be utilized to initiate radical-mediated thiol-ene polymerizations, although this method has been exploited to a much lesser extent. This strategy commonly entails the reduction of peroxides or hydroperoxides to generate free radicals capable of initiating the thiol-ene polymerization. Although thiols can initiate redox cure through reduction of peroxides, the rate of this chemical reaction is typically too slow to be of practical value. To increase the rate of reaction, aromatic amines that serve as electron donors to reduce peroxides are typically added. However, rates of reactions are often difficult to control, with small margins for error between reaction rates that are too fast for application of materials, and slower reactions that do not proceed to completion.

A desirable combination of properties for sealant compositions (i.e., sealants) that has been sought in the art is the combination of a long application time (i.e., the time during which the sealant remains applicable or “open time”) and a short curing time (the time required to reach a predetermined strength). However, long open time typically necessitates a slow overall rate of productivity during manufacturing.

### SUMMARY

Accordingly, new initiator systems that allow control of reaction rate would be of considerable value. The present disclosure provides new initiation systems for the redox polymerization of thiol-ene materials. The initiation package includes peroxides (including hydroperoxides) as the primary source of free-radicals, and various quaternary onium salts that accelerate the rate of the polymerization. Additionally, the optional inclusion of β-dicarbonyl additives, used in combination, can facilitate control of the polymerization rate and reduce the time necessary for curable compositions to reach a tack-free state at the surface.

In one aspect, the present disclosure provides a curable sealant composition comprising components:
a) x weight percent of at least one polythiol;
b) y weight percent of at least one unsaturated compound having at least two non-aromatic carbon-carbon double bonds, at least one carbon-carbon triple bond, or a combination thereof;
c) from 0.01 to 8 weight percent of at least one quaternary ammonium or phosphonium salt;
d) from 0.05 to 10 weight percent of at least one organic peroxide; and
e) optionally from 0.01 to 10 weight percent of a photoinitiator system capable of generating free radicals upon exposure to actinic electromagnetic radiation,
   wherein the curable sealant composition is free of a polyepoxide and an organoboraneamine complex, and
   wherein x and y are positive real numbers, wherein x+y is in the range of 72 to 99, and wherein the weight percent ranges of the components a)-e) are based on the total weight of the components a)-e).

In another aspect, the present disclosure provides a two-part curable sealant composition comprising a Part A composition and a Part B composition, wherein:

the Part A composition comprises at least one polythiol; and

the Part B composition comprises at least one unsaturated compound having at least two non-aromatic carbon-carbon double bonds, at least one carbon-carbon triple bond, or a combination thereof, wherein the Part A composition and the Part B composition collectively comprise components:
a) x weight percent of at least one polythiol;
b) y weight percent of at least one unsaturated compound having at least two non-aromatic carbon-carbon double bonds, at least one carbon-carbon triple bond, or a combination thereof;
c) from 0.01 to 8 weight percent of at least one quaternary ammonium or phosphonium salt;
d) from 0.05 to 10 weight percent of at least one organic peroxide; and
e) optionally from 0.01 to 10 weight percent of a photoinitiator system capable of generating free radicals upon exposure to actinic electromagnetic radiation,
   wherein the two-part curable sealant composition is free of a polyepoxide, and
   wherein x and y are positive real numbers, wherein x+y is in the range of 72 to 99, and wherein the weight percent ranges of the components a)-e) are based on the total weight of the components a)-e).

In yet another aspect, the present disclosure provides a method of making a curable sealant composition, the method comprising:

providing a two-part curable sealant composition comprising a Part A composition and a Part B, wherein:

the Part A composition comprises at least one polythiol; and

the Part B composition comprises at least one unsaturated compound having at least two non-aromatic carbon-carbon double bonds, at least one carbon-carbon triple bond, or a combination thereof, wherein the Part A composition and the Part B composition collectively comprise components:
a) x weight percent of the at least one polythiol;
b) y weight percent of at least one unsaturated compound;
c) from 0.01 to 8 weight percent of at least one quaternary ammonium or phosphonium salt;
d) from 0.05 to 10 weight percent of at least one organic peroxide; and
e) optionally from 0.01 to 10 weight percent of a photoinitiator system capable of generating free radicals upon exposure to actinic electromagnetic radiation,
   wherein x and y are positive real numbers,
   wherein the curable sealant composition is free of polyepoxide, and
   wherein x+y is in the range of 72 to 99, and wherein the weight percent ranges of the components a)-e) are based on the total weight of the components a)-e); and

combining at least a portion of the Part A composition with at least a portion of the Part B composition to provide a curable sealant composition.

In yet another aspect, the present disclosure provides a method of sealing a substrate, the method comprising:

i) applying a curable sealant composition to a surface of the substrate, wherein the curable sealant composition comprises components:
a) x weight percent of the at least one polythiol;
b) y weight percent of at least one unsaturated compound having at least two non-aromatic carbon-carbon double bonds, at least one carbon-carbon triple bond, or a combination thereof;
c) from 0.01 to 8 weight percent of at least one quaternary ammonium or phosphonium salt;
d) from 0.05 to 10 weight percent of at least one organic peroxide; and
e) optionally from 0.01 to 10 weight percent of a photoinitiator system capable of generating free radicals upon exposure to actinic radiation,
   wherein the curable sealant composition is free of polyepoxide, and
   wherein x and y are positive real numbers, wherein x+y is in the range of 72 to 99, and wherein the weight percent ranges of the components a)-e) are based on the total weight of the components a)-e);
ii) optionally exposing at least a portion of the at least one photoinitiator to actinic electromagnetic radiation; and
iii) curing the curable sealant composition throughout its bulk.

In yet another aspect, the present disclosure provides a seal cap comprising:

a cap which defines an interior that is open at one end; and

curable sealant composition disposed within the interior of the seal cap, wherein the curable sealant composition comprises components:
a) x weight percent of at least one polythiol;
b) y weight percent of at least one unsaturated compound having at least two non-aromatic carbon-carbon double bonds, at least one carbon-carbon triple bond, or a combination thereof;
c) from 0.01 to 8 weight percent of at least one quaternary ammonium or phosphonium salt;
d) from 0.05 to 10 weight percent of at least one organic peroxide; and
e) optionally from 0.01 to 10 weight percent of a photoinitiator system capable of generating free radicals upon exposure to actinic radiation,
wherein the curable sealant composition is free of polyepoxide, and
wherein x and y are positive real numbers, wherein x+y is in the range of 72 to 99, and wherein the weight percent ranges of the components a)-e) are based on the total weight of the components a)-e).

As used herein:

the term “actinic radiation” refers to electromagnetic radiation in the region 250 to 720 nanometers ultraviolet that is absorbed directly, or indirectly (e.g., using a photosensitizer), by the photoinitiator system and causing decomposition to form free radicals.

the term “polyepoxide” refers to a compound having two or more epoxy (i.e., oxiranyl) groups.

Features and advantages of the present disclosure will be further understood upon consideration of the detailed description as well as the appended claims.

### BRIEF DESCRIPTION OF THE DRAWINGS

FIG. 1 is a schematic perspective depiction of exemplary seal cap 100 according to the present disclosure.

FIG. 2 is a schematic cross-sectional side view of exemplary seal cap 100.

Repeated use of reference characters in the specification and drawings is intended to represent the same or analogous features or elements of the disclosure. It should be understood that numerous other modifications and embodiments can be devised by those skilled in the art, which fall within the scope and spirit of the principles of the disclosure. The figures may not be drawn to scale.

### DETAILED DESCRIPTION

Curable sealant compositions according to the present disclosure rely on chemical reactions known as thiol-ene and thiol-yne reactions between a thiol and an unsaturated functional group such as an non-aromatic carbon-carbon double bond or a carbon-carbon triple bond.

The thiol-ene reaction is a reaction between a thiol and an alkene to form an alkyl sulfide

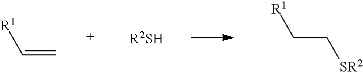

wherein R¹ and R² represent organic groups (e.g., alkyl or aryl).

Likewise, the thiol-yne reaction is a reaction between a thiol and an alkyne to produce an alkenyl sulfide (also known as a vinyl sulfide), as illustrated below:

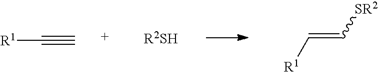

Both reactions are often facilitated by a free-radical initiator and/or UV irradiation. Typically, in a thiol-yne reaction, the first addition of thiol to the alkyne is slower, then a second thiol adds quickly to the vinyl sulfide.

Curable sealant compositions according to the present disclosure may be formulated as one-part curable compositions or as two-part compositions (e.g., a kit) in which the curable sealant composition is divided into two parts, each containing different reactants, thereby preventing premature curing. In use, the two parts (often termed Part A and Part B) are combined to form the corresponding one-part composition, which then cures.

Curable sealant compositions (one-part and two-part) according to the present disclosure comprise components a)-e) as described below. The total amounts of components a)-e) is 100 weight percent. The amount of each component a)-e) is expressed in weight percent as 100×the ratio of the weight of that component divided by the total weight of components a)-e).

Component a) includes at least one polythiol. Component b) includes at least one unsaturated compound having at least two non-aromatic carbon-carbon double bonds, at least one carbon-carbon triple bond, or a combination thereof. Collectively, the total amount of components a) and b) is in the range of 72 to 99 weight percent, based on the total weight of the components a)-e).

In some preferred embodiments, component a) is present in an amount of from 70 to 98 weight percent, preferably 80 to 95 weight percent, and component b) is present in an amount of 2 to 20 weight percent, preferably 3 to 15 weight percent, and more preferably 3 to 10 weight percent, based on the total weight of the components a)-e).

In some preferred embodiments, component a) is present in an amount of 2 to 20 weight percent, preferably 3 to 15 weight percent, and more preferably 3 to 10 weight percent, and component b) is present in an amount of from 70 to 98 weight percent, preferably 80 to 95 weight percent, based on the total weight of the components a)-e).

Useful polythiols are organic compounds having at least two (e.g., at least 2, at least 3, at least 4, or even at least 6) thiol groups.

Generally, in order to achieve chemical crosslinking between polymer chains in the resulting sealant composition, at least one of the polythiol(s) in component a) and/or at least one of the unsaturated compound(s) in component b) has an average equivalent functionality of at least 2, although this is not a requirement. For example, at least one of the polythiol(s) has three or more —SH groups and/or at least one of the unsaturated compound(s) has three or more terminal vinyl groups.

The stoichiometry of components a) and b) expressed as a ratio of —SH groups/vinyl groups preferably is in the range of 0.8 to 1.2, preferably 0.9 to 1.1, and more preferably 0.95 to 1.05, although this is not a requirement.

A variety of polythiols having at least two thiol groups are useful in the method according to the present disclosure. In some embodiments, the polythiol may be an alkylene, arylene, alkylarylene, arylalkylene, or alkylenearylalkylene having at least two mercaptan groups, wherein any of the alkylene, alkylarylene, arylalkylene, or alkylenearylalkylene are optionally interrupted by one or more oxa (i.e., —O—), thia (i.e., —S—), or imino groups (i.e., —NR³— wherein R³ is a hydrocarbyl group or H), and optionally substituted by alkoxy or hydroxyl.

Examples of useful dithiols include 1,2-ethanedithiol, 1,2-propanedithiol, 1,3-propanedithiol, 1,3-butanedithiol, 1,4-butanedithiol, 2,3-butanedithiol, 1,3-pentanedithiol, 1,5-pentanedithiol, 1,6-hexanedithiol, 1,3-dimercapto-3-methylbutane, dipentenedimercaptan, ethylcyclohexyldithiol (ECHDT), dimercaptodiethyl sulfide, methyl-substituted dimercaptodiethyl sulfide, dimethyl-substituted dimercaptodiethyl sulfide, dimercaptodioxaoctane, 1,5-dimercapto-3-oxapentane,benzene-1,2-dithiol, benzene-1,3-dithiol, benzene-1,4-dithiol, and tolylene-2,4-dithiol. Examples of polythiols having more than two mercaptan groups include propane-1,2,3-trithiol; 1,2-bis[(2-mercaptoethyl)thio]-3-mercaptopropane; tetrakis(7-mercapto-2,5-dithiaheptyl)methane; and trithiocyanuric acid.

Also useful are polythiols formed from the esterification of polyols with thiol-containing carboxylic acids or their derivatives. Examples of polythiols formed from the esterification of polyols with thiol-containing carboxylic acids or their derivatives include those made from the esterification reaction between thioglycolic acid or 3-mercaptopropionic acid and several polyols to form the mercaptoacetates or mercaptopropionates, respectively.

Examples of polythiol compounds preferred because of relatively low odor level include, but are not limited to, esters of thioglycolic acid, α-mercaptopropionic acid, and β-mercaptopropionic acid with polyhydroxy compounds (polyols) such as diols (e.g., glycols), triols, tetraols, pentaols, and hexaols. Specific examples of such polythiols include, but are not limited to, ethylene glycol bis(thioglycolate), ethylene glycol bis(β-mercaptopropionate), trimethylolpropane tris(thioglycolate), trimethylolpropane tris(β-mercaptopropionate) and ethoxylated versions, pentaerythritol tetrakis(thioglycolate), pentaerythritol tetrakis(β-mercaptopropionate), and tris(hydroxyethyl)isocyanurate tris(β-mercaptopropionate). However, in those applications where concerns about possible hydrolysis of the ester exist, these polyols are typically less desirable.

Suitable polythiols also include those commercially available as THIOCURE PETMP (pentaerythritol tetra(3-mercaptopropionate)), TMPMP (trimethylolpropane tri(3-mercaptopropionate)), ETTMP (ethoxylated trimethylolpropane tri(3-mercaptopropionate) such as ETTMP 1300 and ETTMP 700), GDMP glycol di(3-mercaptopropionate), TMPMA (trimethylolpropane tri(mercaptoacetate)), TEMPIC (tris[2-(3-mercaptopropionyloxy)ethyl] isocyanurate), and PPGMP (propylene glycol 3-mercaptopropionate) from Bruno Bock Chemische Fabrik GmbH & Co. KG. A specific example of a polymeric polythiol is polypropylene-ether glycol bis(β-mercaptopropionate), which is prepared from polypropylene-ether glycol (e.g., PLURACOL P201, Wyandotte Chemical Corp.) and β-mercaptopropionic acid by esterification.

Suitable polythiols also include those prepared from esterification of polyols with thiol-containing carboxylic acids or their derivatives, those prepared from a ring-opening reaction of epoxides with H₂S (or its equivalent), those prepared from the addition of H₂S (or its equivalent) across carbon-carbon double bonds, polysulfides, polythioethers, and polydiorganosiloxanes. Specifically, these include the 3-mercaptopropionates (also referred to as β-mercaptopropionates) of ethylene glycol and trimethylolpropane (the former from Chemische Fabrik GmbH & Co. KG, the latter from Sigma-Aldrich); POLYMERCAPTAN 805C (mercaptanized castor oil); POLYMERCAPTAN 407 (mercaptohydroxy soybean oil) from Chevron Phillips Chemical Co. LLP, and CAPCURE, specifically CAPCURE 3-800 (a polyoxyalkylenetriol with mercapto end groups of the structure R³[O(C₃H₆O)ₙCH₂CH(OH)CH₂SH]₃ wherein R³ represents an aliphatic hydrocarbon group having 1-12 carbon atoms and n is an integer from 1 to 25), from Gabriel Performance Products, Ashtabula, Ohio, and GPM-800, which is equivalent to CAPCURE 3-800, also from Gabriel Performance Products.

Examples of oligomeric or polymeric polythioethers useful for practicing the present disclosure are described, for example, in U.S. Pat. No. 4,366,307 (Singh et al.), U.S. Pat. No. 4,609,762 (Morris et al.), U.S. Pat. No. 5,225,472 (Cameron et al.), U.S. Pat. No. 5,912,319 (Zook et al.), U.S. Pat. No. 5,959,071 (DeMoss et al.), U.S. Pat. No. 6,172,179 (Zook et al.), and U.S. Pat. No. 6,509,418 (Zook et al.).

In some embodiments, the polythiol in the method according to the present disclosure is oligomeric or polymeric. Examples of useful oligomeric or polymeric polythiols include polythioethers and polysulfides. Polythioethers include thioether linkages (i.e., —S—) in their backbone structures. Polysulfides include disulfide linkages (i.e., —S—S—) in their backbone structures.

Polythioethers can be prepared, for example, by reacting dithiols with dienes, diynes, divinyl ethers, diallyl ethers, ene-ynes, alkynes, or combinations of these under free-radical conditions. Useful dithiols include any of the dithiols listed above. Examples of suitable divinyl ethers include divinyl ether, ethylene glycol divinyl ether, butanediol divinyl ether, hexanediol divinyl ether, diethylene glycol divinyl ether, triethylene glycol divinyl ether, tetraethylene glycol divinyl ether, cyclohexanedimethanol divinyl ether, polytetrahydrofuryl divinyl ether, and combinations of any of these. Useful divinyl ethers of formula CH₂═CHO(R³O)ₘCH═CH₂, in which m is a number from 0 to 10, R³ is C₂ to C₆ branched alkylene. Such compounds can be prepared by reacting a polyhydroxy compound with acetylene. Examples of compounds of this type include compounds in which R³ is an alkyl-substituted methylene group such as —CH(CH₃)— (e.g., those obtained from BASF, Florham Park, N.J., under the trade designation “PLURIOL”, for which R³ is ethylene and m is 3.8) or an alkyl-substituted ethylene (e.g., —CH₂CH(CH₃)— such as those obtained from International Specialty Products of Wayne, N.J., under the trade designation “DPE” (e.g., DPE-2 and DPE-3). Examples of other suitable dienes, diynes, and diallyl ethers include 4-vinyl-1-cyclohexene, 1,5-cyclooctadiene, 1,6-heptadiyne, 1,7-octadiyne, and diallyl phthalate. Small amounts of trifunctional compounds (e.g., triallyl-1,3,5-triazine-2,4,6-trione, 2,4,6-triallyloxy-1,3,5-triazine) may also be useful in the preparation of oligomers.

Examples of oligomeric or polymeric polythioethers useful for practicing the present disclosure are described, for example, in U.S. Pat. No. 4,366,307 (Singh et al.), U.S. Pat. No. 4,609,762 (Morris et al.), U.S. Pat. No. 5,225,472 (Cameron et al.), U.S. Pat. No. 5,912,319 (Zook et al.), U.S. Pat. No. 5,959,071 (DeMoss et al.), U.S. Pat. No. 6,172,179 (Zook et al.), and U.S. Pat. No. 6,509,418 (Zook et al.). In some embodiments, the polythioether is represented by formula HSR⁴[S(CH₂)₂O[R⁵O]ₘ(CH₂)₂SR⁴]ₙSH, wherein each R⁴ and R⁵ is independently a C₂₋₆ alkylene, wherein alkylene may be straight-chain or branched, C₆₋₈ cycloalkylene, C₆₋₁₀ alkylcycloalkylene, —[(CH₂)ₚX]_{q}(CH₂)ᵣ in which at least one —CH₂— is optionally substituted with a methyl group, X is one selected from the group consisting of 0, S and —NR⁶—, where R⁶ denotes hydrogen or methyl, m is a number from 0 to 10, n is a number from 1 to 60, p is an integer from 2 to 6, q is an integer from 1 to 5, and r is an integer from 2 to 10. Polythioethers with more than two mercaptan groups may also be useful.

Polythioethers can also be prepared, for example, by reacting dithiols with diepoxides, which may be carried out by stirring at room temperature, optionally in the presence of a tertiary amine catalyst (e.g., 1,4-diazabicyclo[2.2.2]octane (DABCO)). Useful dithiols include any of those described above. Useful epoxides can be any of those having two epoxide groups. In some embodiments, the diepoxide is a bisphenol diglycidyl ether, wherein the bisphenol (i.e., —OC₆H₅CH₂C₆H₅O—) may be unsubstituted (e.g., bisphenol F), or either of the phenyl rings or the methylene group may be substituted by halogen (e.g., fluoro, chloro, bromo, iodo), methyl, trifluoromethyl, or hydroxymethyl. Polythioethers prepared from dithiols and diepoxides have pendent hydroxyl groups and can have structural repeating units represented by formula —SR⁴SCH₂CH(OH)CH₂OC₆H₅CH₂C₆H₅OCH₂CH(OH)CH₂SR⁴S—, wherein R⁴ is as defined above, and the bisphenol (i.e., —OC₆H₅CH₂C₆H₅O—) may be unsubstituted (e.g., bisphenol F), or either of the phenyl rings or the methylene group may be substituted by halogen (e.g., fluorine, chlorine, bromine, iodine), methyl, trifluoromethyl, or hydroxymethyl. Mercaptan-terminated polythioethers of this type can also be reacted with any of the dienes, diynes, divinyl ethers, diallyl ethers, and ene-ynes listed above under free-radical polymerization conditions.

Other useful polythiols can be formed from the addition of hydrogen sulfide (H₂S) (or its equivalent) across carbon-carbon double bonds. For example, dipentene and triglycerides which have been reacted with H₂S (or its equivalent). Specific examples include dipentene dimercaptan and those polythiols available as POLYMERCAPTAN 358 (mercaptanized soybean oil) and POLYMERCAPTAN 805C (mercaptanized castor oil) from Chevron Phillips Chemical Co. LLP. At least for some applications, the preferred polythiols are POLYMERCAPTAN 358 and 805C since they are produced from largely renewable materials, i.e., the triglycerides, soybean oil and castor oil, and have relatively low odor in comparison to many thiols. Useful triglycerides have at least 2 sites of unsaturation, i.e., carbon-carbon double bonds, per molecule on average, and sufficient sites are converted to result in at least 2 thiols per molecule on average. In the case of soybean oil, this requires a conversion of approximately 42 percent or greater of the carbon-carbon double bonds, and in the case of castor oil this requires a conversion of approximately 66 percent or greater of the carbon-carbon double bonds. Typically, higher conversion is preferred, and POLYMERCAPTAN 358 and 805C can be obtained with conversions greater than approximately 60 percent and 95 percent, respectively. Useful polythiols of this type also include those derived from the reaction of H₂S (or its equivalent) with the glycidyl ethers of bisphenol A epoxy resins, bisphenol F epoxy resins, and novolak epoxy resins. A preferred polythiol of this type is QX11, derived from bisphenol A epoxy resin, from Japan Epoxy Resins (JER) as EPOMATE. Other polythiols suitable include those available as EPOMATE QX10 and EPOMATE QX20 from JER.

Still other useful polythiols are polysulfides that contain thiol groups such as those available as THIOKOL LP-2, LP-3, LP-12, LP-31, LP-32, LP-33, LP-977, and LP-980 from Toray Fine Chemicals Co., Ltd., and polythioether oligomers and polymers such as those described in PCT Publ. No. WO 2016130673 A1 (DeMoss et al.).

Combinations of polythiols may be used. Preferred combinations include miscible mixtures, although this is not a requirement.

Component b) includes at least one unsaturated compound having at least two non-aromatic carbon-carbon double bonds, at least one carbon-carbon triple bond, or a combination thereof. In some preferred embodiments, the non-aromatic carbon-carbon double bonds correspond to vinyl groups.

In some embodiments, the unsaturated compounds are represented by the general formula:

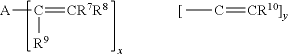

wherein:

A represents an x+y valent organic group (e.g., preferably consisting of C and H, but optionally substituted by hydroxy, alkoxy, aryloxy, carbonyl, acyloxy, carboalkoxy, and sulfur-based derivatives thereof, optionally substituted by one or more of S, N, and P), having from 1 to 8, 12, 18, 22, or even 30 carbon atoms;

each R⁷, R⁸, R⁹, and R¹⁰ independently represents H or an organic group (e.g., alkoxy, acyloxy, alkyl, or aryl) having from 1 to 8 carbon atoms (preferably 1 to 4, and more preferably 1 or 2 carbon atoms)), or R⁷ and R⁸ may together form a 5- or 6-membered ring; and

x and y independently represent integers in the range of 0 to 6, wherein 1≤x+y≤6 with the proviso that if y=0 then x≥2.

Examples of suitable unsaturated compounds include, for example: unsaturated hydrocarbon compounds having from 5 to 30 carbon atoms (preferably 5 to 18 carbon atoms) such as, for example, include 1,4-pentadiene, 1,5-hexadiene, 1,6-heptadiene, 1,7-octadiene, 1,8-nonadiene, 1,9-decadiene, 1,10-undecadiene, 1,11-dodecadiene, 1,13-tetradecadiene, 1,15-hexadecadiene, 1,17-octadecadiene, 1,19-icosadiene, 1,21-docosadiene, divinylbenzene, dicyclopentadiene, limonene, diallylbenzene, triallylbenzene; polyvinyl ethers having from 4 to 30 carbon atoms (preferably 4 to 18) carbon atoms such as, for example, divinyl ether, ethylene glycol divinyl ether, 1,4-butanediol divinyl ether, 1,6-hexanediol divinyl ether, diethylene glycol divinyl ether, triethylene glycol divinyl ether, tetraethylene glycol divinyl ether, cyclohexanedimethanol divinyl ether, trimethylolpropane trivinyl ether, and pentaerythritol tetravinyl ether, bisphenol A divinyl ether, biphenol F divinyl ether, bisphenol A diallyl ether, bisphenol F diallyl ether; diynes having from 5 to 30 carbon atoms (preferably 5 to 15 carbon atoms) such as, for example, 1,6-heptadiyne; isocyanurates having from 9 to 30 carbon atoms (preferably 9 to 15 carbon atoms) such as, for example, diallyl isocyanurate and triallyl isocyanurate; cyanurates having from 9 to 30 carbon atoms (preferably 9 to 15 carbon atoms) such as, for example, diallyl cyanurate, and triallyl cyanurate; and certain ethenyl and/or ethynyl-substituted polymers such as, for example, polytetrahydrofuryl divinyl ether, polyethylene oxide divinyl ether, polyethylene oxide diallyl ether, polypropylene oxide divinyl ether, polypropylene oxide diallyl ether, and mixtures thereof. Ethenyl and/or ethynyl-substituted polymers may have two, three, four, or more ethenyl (e.g., vinyl) and/or ethynyl (e.g., acetylenyl) pendant group and/or end groups. Compounds having both ethenyl and ethynyl groups may also be used. Combinations of the foregoing may be used.

In some embodiments, the carbon-carbon double and triple bonds are terminal groups in a linear aliphatic compound. In some embodiments, one or more of the carbon-carbon double and triple bonds are contained within carbocyclic ring structures having from 4-10 carbon atoms. In some cases, these ring structure may contain multiple fused or bonded rings or heteroatoms such as O, S or N. When using polythiols having two thiol groups, a mixture of unsaturated compounds may be useful in which at least one unsaturated compound has two carbon-carbon double or triple bonds, and at least one unsaturated compound has at least three carbon-carbon double or triple bonds.

Component c) is from 0.01 to 8 (preferably 0.01 to 8, more preferably 0.25 to 3) weight percent of at least one quaternary ammonium or phosphonium salt (collectively termed herein “quaternary onium salt”), wherein the halide is chloride or bromide. In some preferred embodiments, the quaternary ammonium salt comprises an alkylpyridinium salt having from 6 to 30 carbon atoms. In some preferred embodiments, the quaternary ammonium salt and the quaternary phosphonium salt are represented by the formula

(R¹¹)₄M⁺X⁻

M⁺ represents N⁺ or P⁺.

X⁻ represents a non-interfering anion (i.e., an anion that is not detrimental to curing of the curable sealant composition), such as, for example, chloride, bromide, and acetate. Other carboxylates than acetate may also be used such as, for example, propanoate, butyrate, and hexanoate.

Each R¹¹ independently represents a hydrocarbyl group having from 1 to 30 carbon atoms, optionally substituted by up to 3 catenary (i.e., in place of carbon) O or S atoms. Preferably at least one R¹¹ has 1 to 18 carbon atoms, more preferably at least one R¹¹ has 1 to 12 carbon atoms, and still more preferably at least one R¹¹ has 1 to 8 carbon atoms. R¹¹ may be aromatic or aliphatic. Exemplary R11 groups include methyl, ethyl, propyl, butyl, pentyl, hexyl, cyclohexyl, phenyl, heptyl, benzyl, tolyl, octyl, phenethyl, isooctyl, nonyl, decyl, undecyl, dodecyl, cetyl, lauryl, eicosanyl, and docosyl. R¹¹ may be aromatic, branched, linear, and/or cyclic.

Exemplary quaternary ammonium and phosphonium salts include triphenylbenzylphosphonium bromide, chloride, and acetate; tributylallylphosphonium bromide, chloride, and acetate; tributylbenzyl-ammonium bromide, chloride, and acetate; tetrabutylammonium bromide, chloride, and acetate; tetramethylphosphonium bromide, chloride, and acetate; tributylallylphosphonium bromide, chloride, and acetate; tributylbenzylphosphonium bromide, chloride, and acetate; dibutyldiphenylphosphonium bromide, chloride, and acetate; tetrabutylphosphonium bromide, chloride, and acetate; triphenylbenzylphosphonium bromide, chloride, and acetate; and tetraphenylphosphonium bromide, chloride, and acetate; phenyltrimethylammonium bromide, chloride, and acetate; tetrapentylammonium bromide, chloride, and acetate; tetrapropylammonium bromide, chloride, and acetate; tetrahexylammonium bromide, chloride, and acetate; tetraheptylammonium bromide, chloride, and acetate; tetramethylammonium bromide, chloride, and acetate; tetrabutylammonium bromide, chloride, and acetate; benzyltributyl ammonium bromide, chloride, and acetate; tributylallylammonium bromide, chloride, and acetate; tetrabenzylammonium bromide, chloride, and acetate; tetraphenylammonium bromide, chloride, and acetate; cetyltrimethylammonium chloride, benzethonium bromide, chloride, and acetate; tetraoctylammonium bromide, chloride, and acetate.

The quaternary onium salt is generally employed in an effective amount, which is an amount large enough to permit reaction (i.e., curing by polymerizing and/or crosslinking) to readily occur to obtain a polymer of sufficiently high molecular weight for the desired end use. If the amount of quaternary onium salt present is too low, then the reaction may be incomplete. On the other hand, if the amount is too high, then the reaction may proceed too rapidly to allow for effective mixing and use of the resulting composition. Useful rates of reaction will typically depend at least in part on the method of applying the composition to a substrate. Thus, a faster rate of reaction may be accommodated by using a high-speed automated industrial applicator rather than by applying the composition with a hand applicator or by manually mixing the composition.

Within these parameters, an effective amount of the quaternary onium salt is an amount that preferably provides at least 0.003 percent by weight of quaternary onium salt, or at least 0.008 percent by weight of quaternary onium salt, or at least 0.01 percent by weight of quaternary onium salt. An effective amount of the quaternary onium salt is an amount that preferably provides up to 1.5 percent by weight of quaternary onium salt, or up to 0.5 percent by weight of quaternary onium salt, or up to 0.3 percent by weight of quaternary onium salt. The percent by weight of quaternary onium salt in a composition is based on the total weight of the polymerizable material.

Alternatively stated, an effective amount of the quaternary onium salt may be at least 0.1 percent by weight, or at least 0.5 percent by weight. An effective amount of the quaternary onium salt is typically up to 10 percent by weight, up to 5 percent by weight, or up to 3 percent by weight. The percent by weight of quaternary onium salt in a composition is based on the total weight of the polymerizable material.

Preferably, the curable sealant composition is free of organoborane-amine complexes, although this is not a requirement. Organoborane-amine complexes can be used to initiate free-radical polymerization with peroxides and are described in, for example, in U.S. Pat. No. 5,616,796 (Pocius et al.), U.S. Pat. No. 5,621,143 (Pocius), U.S. Pat. No. 6,252,023 (Moren), U.S. Pat. No. 6,410,667 (Moren), and U.S. Pat. No. 6,486,090 (Moren).

Component d) includes from 0.05 to 10 (preferably 0.05 to 10, more preferably 0.75 to 5) weight percent of at least one organic peroxide, based on the total weight of the components a)-e).

Examples of useful organic peroxides include hydroperoxides (e.g., cumene, tert-butyl or tert-amyl hydroperoxide), dialkyl peroxides (e.g., di-tert-butylperoxide, dicumylperoxide, or cyclohexyl peroxide), peroxyesters (e.g., tert-butyl perbenzoate, tert-butyl peroxy-2-ethylhexanoate, tert-butyl peroxy-3,5,5-trimethylhexanoate, tert-butyl monoperoxymaleate, or di-tert-butyl peroxyphthalate), peroxycarbonates (e.g., tert-butylperoxy 2-ethylhexylcarbonate, tert-butylperoxy isopropyl carbonate, or di(4-tert-butylcyclohexyl) peroxydicarbonate), ketone peroxides (e.g., methyl ethyl ketone peroxide, 1,1-di(tert-butylperoxy)cyclohexane, 1,1-di(tert-butylperoxy)-3,3,5-trimethylcyclohexane, and cyclohexanone peroxide), and diacyl peroxides (e.g., benzoyl peroxide or lauryl peroxide). The organic peroxide may be selected, for example, based on the temperature desired for use of the organic peroxide and compatibility with the monomers. Combinations of two or more organic peroxides may also be useful.

In some embodiments, the second initiator comprises an organic hydroperoxide either alone or in combination with a nitrogen-containing base. Organic hydroperoxides have the general structure R¹⁴OOH, wherein R¹⁴ is an alkyl group, aryl group, arylalkylene group, alkylarylene group, alkylarylenealkylene group, or a combination thereof. Examples of useful organic hydroperoxides include cumene hydroperoxide, tert-butyl hydroperoxide, tert-amyl hydroperoxide, 1,1,3,3-tetramethylbutyl hydroperoxide, isopropylcumyl hydroperoxide, p-menthane hydroperoxide (i.e., 1-methyl-1-(4-methylcyclohexyl)ethyl hydroperoxide), diisopropylbenzene hydroperoxide (e.g., 3,5-diisopropylhydroperoxide). In some embodiments, the organic hydroperoxide includes a ketone peroxide (e.g., methyl ethyl ketone peroxide, acetone peroxide, and cyclohexanone peroxide). While organic hydroperoxides tend to be some of the more stable peroxides and require some of the highest temperatures for thermal initiation, we have found that in the presence of a polythiol and unsaturated compound in the composition of the present disclosure, the organic hydroperoxide can initiate curing at room temperature. In some embodiments, compositions according to the present disclosure further comprise a nitrogen-containing base. In some embodiments, a combination of a nitrogen-containing base and an organic hydroperoxide can be considered a redox initiator. The nitrogen atom(s) in the nitrogen-containing base can be bonded to alkyl groups, aryl groups, arylalkylene groups, alkylarylene, alkylarylenealkylene groups, or a combination thereof. The nitrogen-containing base can also be a cyclic compound, which can include one or more rings and can be aromatic or non-aromatic (e.g., saturated or unsaturated). Cyclic nitrogen-containing bases can include a nitrogen as at least one of the atoms in a 5- or 6-membered ring. In some embodiments, the nitrogen-containing base includes only carbon-nitrogen, nitrogen-hydrogen, carbon-carbon, and carbon-hydrogen bonds. In some embodiments, the nitrogen-containing base can be substituted with at least one of alkoxy, aryl, arylalkylenyl, haloalkyl, haloalkoxy, halogen, nitro, hydroxy, hydroxyalkyl, mercapto, cyano, aryloxy, arylalkyleneoxy, heterocyclyl, or hydroxyalkyleneoxyalkylenyl. In some embodiments, the nitrogen-containing base is a tertiary amine. Examples of useful tertiary amines include triethylamine, dimethylethanolamine, benzyldimethylamine, dime thylaniline, tribenzylamine, triphenylamine, N,N-dimethyl-p-toluidine, N,N-dimethyl-o-toluidine, tetramethylguanidine (TMG), 1,8-diazabicyclo[5.4.0]undec-7-ene (DBU), 1,5-diazabicyclo[4.3.0]non-5-ene (DBN), 1,4-diazabicyclo[2.2.2]octane (DABCO), quinuclidine, 3-quinuclidinol, dimethylaminomethylphenol, tris(dimethylaminomethyl)phenol, N,N-dihydroxyethyl-p-toluidine, N,N-diisopropylethylamine, and N, N, N′, N″, N″-pentamethyl-diethylenetriamine. Useful nitrogen-containing bases also include guanidines such as diphenylguanidine (DPG). In some embodiments, the nitrogen-containing base comprises a substituted or unsubstituted nitrogen-containing ring. In some embodiments, the substituted or unsubstituted nitrogen-containing ring has 5 or 6 atoms in the ring. The substituted or unsubstituted nitrogen-containing ring can be aromatic or nonaromatic and can have up to 4 nitrogen atoms in the ring. The ring can optionally include other heteroatoms (e.g., S and O). Substituted aromatic or nonaromatic rings can be substituted by one or more substituents independently selected from the group consisting of alkyl, aryl, arylalkylenyl, alkoxy, haloalkyl, haloalkoxy, halogen, nitro, hydroxy, hydroxyalkyl, mercapto, cyano, aryloxy, arylalkylenoxy, heterocyclyl, hydroxyalkylenoxyalkylenyl, amino, alkylamino, dialkylamino, (dialkylamino)alkylenoxy, and oxo. The alkyl substituent can be unsubstituted or substituted by at least one of alkoxy having up to 4 carbon atoms, halo, hydroxy, or nitro. In some embodiments, the aryl or arylalkylenyl is unsubstituted or substituted by at least one of alkyl having up to 4 carbon atoms, alkoxy having up to 4 carbon atoms, halo, hydroxy, or nitro. In some embodiments, the nitrogen-containing base is a substituted or unsubstituted pyridine, pyrazine, imidazole, pyrazole, tetrazole, triazole, oxazole, thiazole, pyrimidine, pyridazine, triazine, tetrazine, or pyrrole. Any of these may be substituted with halogen (e.g., iodo, bromo, chloro, fluoro), alkyl (e.g., having from 1 to 4, 1 to 3, or 1 to 2 carbon atoms), arylalkylenyl (e.g., benzyl), or aryl (phenyl). In some embodiments, the nitrogen-containing base, is a substituted or unsubstituted imidazole or pyrazole. The imidazole or pyrazole may be substituted with halogen (e.g., iodo, bromo, chloro, fluoro), alkyl (e.g., having from 1 to 4, 1 to 3, or 1 to 2 carbon atoms), arylalkylenyl (e.g., benzyl), or aryl (phenyl). Examples of useful nitrogen-containing rings include 1-benzylimidazole, 1,2-dimethylimidazole, 4-iodopyrazole, 1-methylbenzimidazole, 1-methylpyrazole, 3-methylpyrazole, 4-phenylimidazole, and pyrazole.

Organic peroxides, in some embodiments organic hydroperoxides, can be added in any amount suitable to initiate curing. In some embodiments, the organic peroxide is present in an amount in a range from 0.05 weight percent to about 10 weight percent (in some embodiments, 0.1 weight percent to 5 weight percent, or 0.5 weight percent to 5 weight percent). The organic peroxide and its amount may be selected to provide the composition with a desirable second time period (that is, the length of time a portion of the curable sealant adjacent the surface of the aircraft remains liquid) after it is mixed or thawed. In some embodiments, the composition has an open time of at least 10 minutes, at least 30 minutes, at least one hour, or at least two hours.

Optional component e) consists of from 0.01 to 10 weight percent (preferably 0.1 to 1.5 weight percent), based on the total weight of the components a)-e), of a photoinitiator system capable of generating free radicals upon exposure to actinic radiation (preferably electromagnetic radiation). Typically, the actinic radiation will be electromagnetic radiation including wavelengths in the range of 250 to 500 nanometers (nm), although other wavelengths may be used. In preferred embodiments, the actinic radiation is visible, and preferably contains electromagnetic radiation in the 400 to 470 nm wavelength range (more preferably 440-460 nm). The photoinitiator system may include Type-I and/or Type-II photoinitiators, sensitizing dyes, amine synergists, and optionally electron donors (e.g., as in the case of 3-component electron-transfer photoinitiators), for example.

Examples of suitable free-radical photoinitiators include 2-benzyl-2-(dimethylamino)-4′-morpholinobutyrophenone; 1-hydroxycyclohexylphenyl ketone; 2-methyl-1-[4-(methylthio)phenyl]-2-morpholinopropan-1-one; 4-methylbenzophenone; 4-phenyl benzophenone; 2-hydroxy-2-methyl-1-phenylpropanone; 1-[4-(2-hydroxyethoxyl)-phenyl]-2-hydroxy-2-methylpropanone; 2,2-dimethoxy-2-phenylacetophenone; 4-(4-methylphenylthio)benzophenone; benzophenone; 2,4-diethylthioxanthone; 4,4′-bis(diethylamino)benzophenone; 2-isopropylthioxanthone; and combinations thereof. Many of these and others are widely available from commercial sources.

Preferably, the photoinitiator system comprises a free-radical photoinitiator that is sensitive to wavelengths in the visible region of the electromagnetic spectrum. Examples of such photoinitiators include acylphosphine oxide derivatives, acylphosphinate derivatives, and acylphosphine derivatives (e.g., phenylbis(2,4,6-trimethylbenzoyl)phosphine oxide (available as OMNIRAD 819 from IGM Resins, St. Charles, Ill.), phenylbis(2,4,6-trimethylbenzoyl)phosphine (e.g., as available as OMNIRAD 2100 from IGM Resins), bis(2,4,6-trimethylbenzoyl)phenylphosphine oxide, 2,4,6-trimethylbenzoyldiphenyl-phosphine oxide (e.g., as available as OMNIRAD 8953X from IGM Resins), isopropoxyphenyl-2,4,6-trimethylbenzoylphosphine oxide, dimethyl pivaloylphosphonate), ethyl (2,4,6-trimethylbenzoyl) phenyl phosphinate (e.g., as available as OMNIRAD TPO-L from IGM Resins); and, bis(cyclopentadienyl) bis[2,6-difluoro-3-(1-pyrryl)phenyl] titanium (e.g., as available as OMNIRAD 784 from IGM Resins).

While these photoinitiators may have low molar extinction coefficients at 450 nm, they nonetheless are typically sufficiently absorptive to provide sufficient curing using light emitting diode (LED) light sources at the indicated amounts.

Optionally, the curable sealant composition may include one or more basic compounds such as, for example, amines such as 1,4-diazobicyclo[2.2.2]octane (DABCO), 1,2-dimethylimidazole, 3-quinuclidinol, and/or excess amine supplied with the organoborane-amine complex, and/or inorganic bases (e.g., magnesium hydroxide, sodium hydroxide, calcium hydroxide, calcium oxide, and sodium carbonate). If included, typical amounts are 0.1 to 8 weight percent, preferably 0.2 to 2 percent, although this is not a requirement.

In some embodiments, curable sealant compositions useful for practicing the present disclosure comprise at least one adhesion promoter. Adhesion promoter may be present, for example, in an amount of from 0.1 weight percent to 15 weight percent of the curable sealant, preferably less than 5 weight percent, more preferably less than 2 weight percent, or even less than 1 weight percent, based on the total weight of the curable sealant composition.

Examples of adhesion promoters include phenolics, such as a phenolic resin available as METHYLON, epoxy resins such as low molecular weight bisphenol A diglycidyl ethers, organosilanes, such as epoxy-, mercapto- or amino-functional silanes, organotitanates, and organozirconates. Examples of mercaptosilanes useful as adhesion promoters include γ-mercaptopropyltrimethoxysilane, γ-mercapto-propyltriethoxysilane, γ-mercaptopropylmethyldimethoxysilane, γ-mercaptopropylmethyldiethoxysilane, mercaptomethyltrimethoxysilane, mercaptomethyltriethoxysilane, and combinations thereof. In some embodiments, useful organosilanes have amino functional groups (e.g., N-2-(aminoethyl)-3-aminopropyl-trimethoxysilane and (3-aminopropyl)trimethoxysilane). In some embodiments, useful adhesion promoters have groups polymerizable by, for example, free-radical polymerization. Examples of polymerizable moieties are materials that contain olefinic functionality such as styrenic, vinyl (e.g., vinyltriethoxysilane, vinyltri(2-methoxyethoxy)silane), acrylic and methacrylic moieties (e.g., 3-methacryloxypropyltrimethoxysilane). Some functional silanes useful as adhesion promoters are commercially available, for example, from Momentive Performance Materials, Inc., Waterford, N.Y., as SILQUEST A-187 and SILQUEST A-1100. Other useful adhesion promoters are known in the art. In some embodiments of mercaptan-functional adhesion promoters, the adhesion promoter has a mercaptan equivalent weight of less than 5000 g/mole (g/mol), 4000 g/mol, 3000 g/mol, 2000 g/mol, or 1000 g/mol as determined by mercaptan titration so that they may more easily migrate within the curable sealant composition. Other functional adhesion promoters (e.g., amino- or epoxy-silanes) can also have equivalent weights of less than 5000 g/mol, 4000 g/mol, 3000 g/mol, 2000 g/mol, or 1000 g/mol as determined by titration. Many titanate and zirconate coupling agents are commercially available.

Examples of suitable wetting agents include a silicone, modified silicone, silicone acrylate, hydrocarbon solvent, fluorine-containing compound, non-silicone polymer or copolymer such as a co-polyacrylate, and mixtures thereof. Examples of nonionic surfactants suitable as wetting agents in the curable sealant compositions disclosed herein include block copolymers of polyethylene glycol and polypropylene glycol, polyoxyethylene (7) lauryl ether, polyoxyethylene (9) lauryl ether, polyoxyethylene (18) lauryl ether, and polyethoxylated alkyl alcohols such as those available, for example, from Air Products and Chemicals Inc., Allentown, Pa., as SURFYNOL SE-F. Fluorochemical surfactants such as those available under the trade designation FLUORAD from 3M Company of St. Paul, Minn., may also be useful. In some embodiments, the curable sealant composition includes at least about 0.001 weight percent, at least about 0.01 weight percent, or at least about 0.02 weight percent of at least one wetting agent and up to about 2 weight percent, up to about 1.5 weight percent, or up to about 1 weight percent of at least one wetting agent, based on the total weight of the curable sealant composition.

Adhesion promoters or wetting agents may be directly incorporated into the curable sealant composition, used as a separate and distinct primer composition that is coated onto the substrate prior to the application of the curable sealant composition or more commonly a combination of both approaches. It should be appreciated that the total amount of adhesion promoter or wetting agent which is used, regardless of whether the technique for adhesion promotion is integral blending or priming or both, should be sufficient to enhance the adhesion of the curable sealant composition to the substrate under all conditions of intended or expected use.

The components of the curable sealant composition (including two-part compositions) may be present in the solvent at any suitable concentration, (e.g., from about 5 percent to about 90 percent by weight based on the total weight of the solution). In some embodiments, each component may be present in a range from 10 to 85 or 25 to 75 percent by weight, based on the total weight of the solution. Illustrative examples of suitable solvents include aliphatic and alicyclic hydrocarbons (e.g., hexane, heptane, and cyclohexane), aromatic solvents (e.g., benzene, toluene, and xylene), ethers (e.g., diethyl ether, glyme, diglyme, and diisopropyl ether), esters (e.g., ethyl acetate and butyl acetate), alcohols (e.g., ethanol and isopropyl alcohol), ketones (e.g., acetone, methyl ethyl ketone, and methyl isobutyl ketone), sulfoxides (e.g., dimethyl sulfoxide), amides (e.g., N,N-dimethylformamide and N,N-dimethylacetamide), halogenated solvents (e.g., methylchloroform, 1,1,2-trichloro-1,2,2-trifluoroethane, trichloroethylene, and trifluorotoluene), and mixtures thereof.

Curable sealant compositions useful for practicing the method of the present disclosure can also contain fillers. Conventional inorganic fillers such as silica (e.g., fumed silica), calcium carbonate, aluminum silicate, and carbon black may be useful as well as low density fillers. In some embodiments, the curable sealant disclosed herein includes at least one of silica, hollow ceramic elements, hollow polymeric elements, calcium silicates, calcium carbonate, or carbon black. Silica, for example, can be of any desired size, including particles having an average size above 1 micrometer, between 100 nanometers and 1 micrometer, and below 100 nanometers. Silica can include nanosilica and amorphous fumed silica, for example. Suitable low density fillers may have a specific gravity ranging from about 1.0 to about 2.2 and are exemplified by calcium silicates, fumed silica, precipitated silica, and polyethylene. Examples include calcium silicate having a specific gravity of from 2.1 to 2.2 and a particle size of from 3 to 4 microns (available as HUBERSORB HS-600, J. M. Huber Corp., Edison N.J.) and fumed silica having a specific gravity of 1.7 to 1.8 with a particle size less than 1 (CAB-O-SIL TS-720, Cabot Corp., Boston, Mass.). Other examples include precipitated silica having a specific gravity of from 2 to 2.1 (available as HI-SIL TS-7000, PPG Industries, Pittsburgh, Pa.), and polyethylene having a specific gravity of from 1 to 1.1 and a particle size of from 10 to 20 microns (available as SHAMROCK S-395 Shamrock Technologies Inc.).

Additional fillers include hollow elements such as, for example, organic and inorganic hollow elements. Hollow inorganic elements and hollow organic elements may have one of a variety of useful sizes but typically have a maximum dimension of less than 10 millimeters (mm), more typically less than one mm. The specific gravities of the microspheres range from about 0.1 to 0.7 and are exemplified by microspheres of polyacrylates and polyolefins, and silica microspheres having particle sizes ranging from 5 to 100 microns and a specific gravity of 0.25 (ECCOSPHERES, W. R. Grace & Co.). Other examples include elastomeric particles available, for example, from Akzo Nobel, Amsterdam, The Netherlands, as EXPANCEL, alumina/silica microspheres having particle sizes in the range of 5 to 300 microns and a specific gravity of 0.7 (available as FILLITE, Pluess-Stauffer International), aluminum silicate microspheres having a specific gravity of from about 0.45 to about 0.7 (Z-LIGHT), and calcium carbonate-coated polyvinylidene copolymer microspheres having a specific gravity of 0.13 (DUALITE 6001AE, Pierce & Stevens Corp., Buffalo, N.Y.). Further examples of commercially available materials include glass bubbles marketed by 3M Company, Saint Paul, Minn., as 3M GLASS BUBBLES in grades K1, K15, K20, K25, K37, K46, S15, S22, S32, S35, S38, S38HS, S38XHS, S42HS, S42XHS, S60, S60HS, iM30K, iM16K, iM16K-N, iM30K-N, XLD3000, XLD6000, and G-65, and any of the HGS series of 3M GLASS BUBBLES; glass bubbles from Potters Industries, Carlstadt, N.J., as Q-CEL HOLLOW SPHERES (e.g., grades 30, 6014, 6019, 6028, 6036, 6042, 6048, 5019, 5023, and 5028); and hollow glass particles from Silbrico Corp., Hodgkins, Ill., as SIL-CELL (e.g., grades SIL 35/34, SIL-32, SIL-42, and SIL-43). Such fillers, alone or in combination, can be present in a sealant in a range from 10 percent by weight to 55 percent by weight, in some embodiments, 20 percent by weight to 50 percent by weight, based on the total weight of the curable sealant composition. The presence of filler in the curable sealant also has the advantageous effect of increasing the open time of the curable sealant composition in some cases.

Optionally, but preferably, the curable sealant composition may contain at least one β-dicarbonyl additive which, in combination with the onium salt halide, can assist in controlling the polymerization rate and reduce the time necessary for formulations to reach a tack-free state at the surface. Exemplary 1,3-dicarbonyl compounds include methyl acetoacetate, ethyl acetoacetate, tert-butyl acetoacetate, diethylene glycol bis(acetoacetate), polycaprolactone tris(acetoacetate), polypropylene glycol bis(acetoacetate), acetoacetanilide, ethylene bis(acetoacetamide), polypropylene glycol bis(acetoacetamide), acetoacetamide, and acetoacetonitrile. Preferred 1,3-dicarbonyl compounds include dimedone, barbituric acid and their derivatives (e.g., 1,3-dimethylbarbituric acid, 1-phenyl-5-benzylbarbituric acid, and 1-ethyl-5-cyclohexyl-barbituric acid).

If present, the amount of at least one β-dicarbonyl additive is preferably in an amount of 0.01 to 10 percent by weight, more preferably 0.1 to 5 percent by weight, based on the total weight of the curable sealant composition, although this is not a requirement.

Curable sealant compositions useful for practicing the method of the present disclosure can also contain at least one of cure accelerators, colorants (e.g., pigments and dyes), thixotropic agents, and solvents. The solvent can conveniently be any material (e.g., tetrahydrofuran, ethyl acetate, or those described below) capable of dissolving a component of the curable sealant. Suitable pigments and dyes can include those that do not absorb in the wavelength range that is desirable for curing the composition.

In order to provide long storage shelf life, curable sealant compositions according to the present disclosure may be frozen or provided as two-part compositions, for example.

Two-part curable sealant compositions comprise a Part A composition and a Part B composition, both of which have good shelf life, but when combined have a reduced shelf life. When combining the Part A and Part B compositions effort should be made to mix them well using active (e.g., mechanical stirrer) and/or passive mixing techniques (e.g., static mixer nozzles). In preferred two-part curable sealant compositions, the ingredients of the one-part curable sealant composition are divided into separate containers (e.g., sealed tubes or cartridges) as follows: the Part A composition comprises the at least one polythiol, the Part B composition comprises the at least one unsaturated compound having at least two non-aromatic carbon-carbon double bonds, at least one carbon-carbon triple bond, or a combination thereof, and the remaining ingredients may be present in either or both of the Part A composition or the Part B composition.

Curable sealant compositions according to the present disclosure can generally be made by simply combining, using mixing techniques well-known in the art, at least a portion of the Part A composition with at least a portion of the Part B composition to provide the curable sealant composition.

In use, a (preferably flowable) curable sealant composition according to the present disclosure is applied to a surface of a substrate and cured. Preferably, the curable sealant composition is formulated to be flowable at the application temperature, however this is not a requirement.

For curable sealant composition containing photoinitiator, once applied, the curable sealant composition may be exposed to actinic radiation. Examples of suitable sources of actinic radiation include high pressure mercury arc lamps, LED lamps (e.g., similar to those used for dental restorations), xenon flash lamps, and sunlight (e.g., focused sunlight). Exposure times may be from seconds to minutes, although other times may also be used. After exposure, the curable sealant composition cures over time. Advantageously, curable sealant compositions according to the present disclosure typically have satisfactory open/working time, but can be triggered by exposure to light to cause rapid onset of curing. Even though light is used to initiate curing, the other curative(s) present ensures effective curing in areas not exposed to the light.

The curable sealant composition is typically applied to one or more (e.g., two) substrates. Exemplary substrate materials include glass, plastic, metal (e.g., copper, steel, titanium, stainless steel, and aluminum, any of which may be anodized, primed, organic-coated or chromate-coated), composites (e.g., carbon-fiber composites and fiberglass composites), ceramic, and combinations thereof. In some preferred embodiments, the substrate(s) comprises an aircraft or marine vessel component. Exemplary aircraft components include seams or joints between portions of aircraft skin, aircraft fasteners, aircraft windows, aircraft access panels, fuselage protrusions, and aircraft fuel tanks.

Curable sealant compositions in the method according to the present disclosure can be cured into, for example, aviation-fuel-resistant sealants. Aviation-fuel-resistant sealants are widely used by the aircraft industry for many purposes. Commercial and military aircraft are typically built by connecting a number of structural members, such as longitudinal stringers and circular frames. The aircraft skin, whether metal or composite, is attached to the outside of the stringers using a variety of fasteners and adhesives. These structures often include gaps along the seams, joints between the rigidly interconnected components, and overlapping portions of the exterior aircraft skin. The method according to the present disclosure can be useful, for example, for sealing such seams, joints, and overlapping portions of the aircraft skin. The curable sealant composition may be applied, for example, to aircraft fasteners, windows, access panels, and fuselage protrusions. After curing, the resulting sealant disclosed herein may prevent the ingress of weather and may provide a smooth transition between the outer surfaces to achieve desired aerodynamic properties. The method according to the present disclosure may likewise be carried out on interior assemblies to prevent corrosion, to contain the various fluids and fuels necessary to the operation of an aircraft, and to allow the interior of the aircraft (e.g., the passenger cabin) to maintain pressurization at higher altitudes. Among these uses are the sealing of integral fuel tanks and cavities.

Aircraft exterior and interior surfaces, to which sealants may be applied, may include metals such as titanium, stainless steel, and aluminum, and/or composites, any of which may be anodized, primed, organic-coated or chromate-coated. For example, a dilute solution of one or more phenolic resins, organofunctional silanes, titanates and/or zirconates, and a surfactant or wetting agent dissolved in organic solvent or water may be applied to an exterior or interior surface and dried.

Sealants may optionally be used in combination with a seal cap, for example, over rivets, bolts, or other types of fasteners. A seal cap may be made using a seal cap mold, filled with a curable sealant, and placed over a fastener. The curable sealant may then be cured. In some embodiments, the seal cap and the curable sealant may be made from the same material. For more details regarding seal caps, see, for example, PCT Pub. No. WO2014/172305 (Zook et al.).

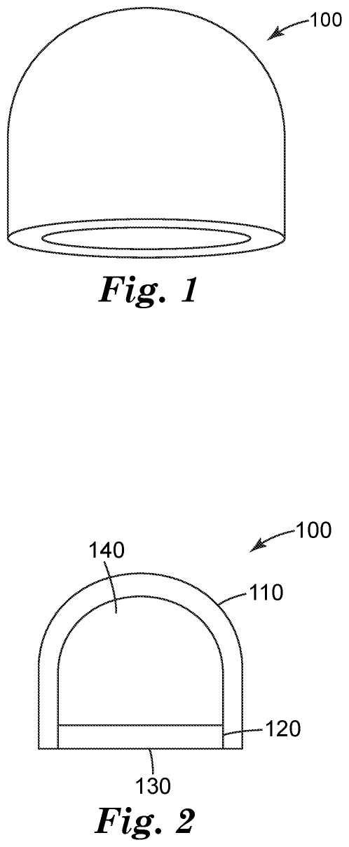

Referring now to FIGS. 1 and 2, seal cap 100 comprises cap 110 defining interior 120 that is open at one end 130. Curable sealant composition 140 according to the present disclosure is disposed within the interior of the seal cap.

The cap can be made of any suitable material. Examples include cured sealant according to the present disclosure, rubber, synthetic elastomers, thermoplastic polymers (e.g., polycarbonate, polyester, acrylics), metal, and combinations thereof. In some embodiments, the cap is partially filled with sealant, while in others, it is completely filled. In some embodiments, the cap is at least partially filled with sealant shortly before use.

In some embodiments, the cap is at least partially filled with sealant and stored in ready-to-use form. In some such embodiments, the seal cap is preferably stored at low temperature, and must be warmed before use. In some embodiments, the cap is at least partially filled with sealant prior to application to a fastener. In some embodiments, the cap is at least partially filled with sealant after application to a fastener, e.g., by syringe, by a sealant port, or the like.

In some embodiments, the seal cap is applied to a fastener after application of sealant to the fastener. In some embodiments, the fastener penetrates a substrate. In some embodiments, the fastener protrudes from a surface of a substrate. In some embodiments, the substrate comprises a composite material. In some embodiments, the substrate comprises an epoxy matrix and glass or carbon fiber composite material. In some embodiments, every portion of the fastener which protrudes from the substrate is covered by cured sealant or seal cap or both. In some embodiments, every portion of the fastener which protrudes from the substrate is covered by cured sealant.

In some embodiments, curable sealant compositions, and cured forms thereof prepared from the method according to the present disclosure may be useful in these applications, for example, because of their fuel resistance and low glass transition temperatures.

### SELECT EMBODIMENTS OF THE PRESENT DISCLOSURE

In a first embodiment, the present disclosure provides a curable sealant composition comprising components:
a) x weight percent of at least one polythiol;
b) y weight percent of at least one unsaturated compound having at least two non-aromatic carbon-carbon double bonds, at least one carbon-carbon triple bond, or a combination thereof;
c) from 0.01 to 8 weight percent of at least one quaternary ammonium or phosphonium salt;
d) from 0.05 to 10 weight percent of at least one organic peroxide; and
e) optionally from 0.01 to 10 weight percent of a photoinitiator system capable of generating free radicals upon exposure to actinic electromagnetic radiation wavelength range (preferably at about 450 nm),
   wherein the curable sealant composition is free of a polyepoxide and an organoborane-amine complex, and
   wherein x and y are positive real numbers, wherein x+y is in the range of 72 to 99, and wherein the weight percent ranges of the components a)-e) are based on the total weight of the components a)-e).

In a second embodiment, the present disclosure provides a curable sealant composition according to the first embodiment, further wherein the curable sealant composition is free of an organoborane-amine complex.

In a third embodiment, the present disclosure provides a curable sealant composition according to the first or second embodiment, wherein the curable sealant composition comprises:
a) from 70 to 98 weight percent of the at least one polythiol;
b) from 2 to 20 weight percent of the at least one unsaturated compound;
c) from 0.01 to 8 weight percent of the at least one quaternary ammonium or phosphonium salt;
d) from 0.05 to 10 weight percent of the at least one organic peroxide; and
e) optionally from 0.01 to 10 weight percent of a photoinitiator system capable of generating free radicals upon exposure to actinic electromagnetic radiation (preferably at about 450 nm).

In a fourth embodiment, the present disclosure provides a curable sealant composition according to any one of the first to third embodiments, wherein the curable sealant composition comprises:
a) from 80 to 95 weight percent of the at least one polythiol;
b) from 3 to 10 weight percent of the at least one unsaturated compound;
c) from 0.25 to 3 weight percent of the at least one quaternary ammonium or phosphonium salt;
d) from 0.75 to 5 weight percent of the at least one organic peroxide; and
e) optionally from 0.01 to 10 weight percent of a photoinitiator system capable of generating free radicals upon exposure to actinic electromagnetic radiation (preferably at about 450 nm).

In a fifth embodiment, the present disclosure provides a curable sealant composition according to any one of the first to fourth embodiments, further comprising at least one of an adhesion promoter or a wetting agent.

In a sixth embodiment, the present disclosure provides a curable sealant composition according to any one of the first to fifth embodiments, wherein the at least one polythiol comprises an aliphatic polythiol.

In a seventh embodiment, the present disclosure provides a curable sealant composition according to any one of the first to sixth embodiments, wherein the at least one unsaturated compound comprises a compound having at least two vinyl groups.

In an eighth embodiment, the present disclosure provides a curable sealant composition according to any one of the first to seventh embodiments, wherein the quaternary ammonium salt and the quaternary phosphonium salt are represented by the formula (R¹¹)₄M⁺X⁻, wherein:

M represents N or P;

each R¹¹ independently represents a hydrocarbyl group having from 1 to 22 carbon atoms; and X represents Cl, Br, or acetate.

In a ninth embodiment, the present disclosure provides a curable sealant composition according to any one of the first to eighth embodiments, wherein component e) is present.

In a tenth embodiment, the present disclosure provides a curable sealant composition according to any one of the first to ninth embodiments, wherein the photoinitiator system comprises an acylphosphine oxide.

In an eleventh embodiment, the present disclosure provides a curable sealant composition according to any one of the first to tenth embodiments, further comprising component:

f) from 0.01 to 8 weight percent of at least one β-dicarbonyl compound, wherein the weight percent is based on the total weight of the components a)-f).

In a twelfth embodiment, the present disclosure provides a two-part curable sealant composition comprising a Part A composition and a Part B composition, wherein:

the Part A composition comprises at least one polythiol; and

the Part B composition comprises at least one unsaturated compound having at least two non-aromatic carbon-carbon double bonds, at least one carbon-carbon triple bond, or a combination thereof, wherein the Part A composition and the Part B composition collectively comprise components:
a) x weight percent of at least one polythiol;
b) y weight percent of at least one unsaturated compound having at least two non-aromatic carbon-carbon double bonds, at least one carbon-carbon triple bond, or a combination thereof;
c) from 0.01 to 8 weight percent of at least one quaternary ammonium or phosphonium salt;
d) from 0.05 to 10 weight percent of at least one organic peroxide; and
e) optionally from 0.01 to 10 weight percent of a photoinitiator system capable of generating free radicals upon exposure to actinic electromagnetic radiation (preferably at about 450 nm),
   wherein the two-part curable sealant composition is free of a polyepoxide, and
   wherein x and y are positive real numbers, wherein x+y is in the range of 72 to 99, and wherein the weight percent ranges of the components a)-e) are based on the total weight of the components a)-e).

In a thirteenth embodiment, the present disclosure provides a two-part curable sealant composition according to the twelfth embodiment, further wherein the two-part curable sealant composition is free of an organoborane-amine complex.

In a fourteenth embodiment, the present disclosure provides a two-part curable sealant composition according to the twelfth or thirteenth embodiment, wherein the components comprise:
a) from 70 to 98 weight percent of the at least one polythiol;
b) from 2 to 20 weight percent of the at least one unsaturated compound;
c) from 0.01 to 8 weight percent of the at least one quaternary ammonium or phosphonium salt;
d) from 0.05 to 10 weight percent of the at least one organic peroxide; and
e) optionally from 0.01 to 10 weight percent of the photoinitiator system capable of generating free radicals upon exposure to actinic radiation (preferably at about 450 nm).

In a fifteenth embodiment, the present disclosure provides a two-part curable sealant composition according to any one of the twelfth to fourteenth embodiments, wherein the components comprise:
a) from 80 to 95 weight percent of the at least one polythiol;
b) from 3 to 10 weight percent of the at least one unsaturated compound;
c) from 0.25 to 3 weight percent of the at least one quaternary ammonium or phosphonium salt;
d) from 0.75 to 5 weight percent of the at least one organic peroxide; and
e) optionally from 0.1 to 1.5 weight percent of the photoinitiator system capable of generating free radicals upon exposure to actinic radiation (preferably at about 450 nm).

In a sixteenth embodiment, the present disclosure provides a two-part curable sealant composition according to any one of the twelfth to fifteenth embodiments, further comprising at least one of an adhesion promoter or a wetting agent.

In a seventeenth embodiment, the present disclosure provides a two-part curable sealant composition according to any one of the twelfth to sixteenth embodiments, wherein the at least one polythiol comprises an aliphatic polythiol.

In an eighteenth embodiment, the present disclosure provides a two-part curable sealant composition according to any one of the twelfth to seventeenth embodiments, wherein the at least one unsaturated compound comprises a compound having at least two vinyl groups.

In a nineteenth embodiment, the present disclosure provides a two-part curable sealant composition according to any one of the twelfth to eighteenth embodiments, wherein the quaternary ammonium salt and the quaternary phosphonium salt are represented by the formula (R¹¹)₄M⁺X⁻, wherein:

M represents N or P;

each R¹¹ independently represents a hydrocarbyl group having from 1 to 22 carbon atoms; and

X represents Cl, Br, or acetate.

In a twentieth embodiment, the present disclosure provides a two-part curable sealant composition according to any one of the twelfth to nineteenth embodiments, wherein component e) is present.

In a twenty-first embodiment, the present disclosure provides a two-part curable sealant composition according to any one of the twelfth to twentieth embodiments, wherein the at least one photoinitiator comprises an acylphosphine oxide.

In a twenty-second embodiment, the present disclosure provides a two-part curable sealant composition according to any one of the twelfth to twenty-first embodiments, further comprising component:

f) from 0.01 to 8 weight percent of at least one β-dicarbonyl compound, wherein the weight percent is based on the total weight of the components a)-f).

In a twenty-third embodiment, the present disclosure provides a method of making a curable sealant composition, the method comprising:

providing a two-part curable sealant composition comprising a Part A composition and a Part B, wherein:

the Part A composition comprises at least one polythiol; and

the Part B composition comprises at least one unsaturated compound having at least two non-aromatic carbon-carbon double bonds, at least one carbon-carbon triple bond, or a combination thereof, wherein the Part A composition and the Part B composition collectively comprise components:
a) x weight percent of the at least one polythiol;
b) y weight percent of at least one unsaturated compound;
c) from 0.01 to 8 weight percent of at least one quaternary ammonium or phosphonium salt;
d) from 0.05 to 10 weight percent of at least one organic peroxide; and
e) optionally from 0.01 to 10 weight percent of a photoinitiator system capable of generating free radicals upon exposure to actinic radiation (preferably at about 450 nm),
   wherein x and y are positive real numbers,
   wherein the curable sealant composition is free of polyepoxide, and
   wherein x+y is in the range of 72 to 99, and wherein the weight percent ranges of the components a)-e) are based on the total weight of the components a)-e); and

combining at least a portion of the Part A composition with at least a portion of the Part B composition to provide a curable sealant composition.

In a twenty-fourth embodiment, the present disclosure provides a method according to the twenty-third embodiment, wherein the curable sealant composition is free of an organoborane-amine complex.

In a twenty-fifth embodiment, the present disclosure provides a method of sealing a substrate, the method comprising:
i) applying a curable sealant composition to a surface of the substrate, wherein the curable sealant composition comprises components:
   a) x weight percent of the at least one polythiol;
   b) y weight percent of at least one unsaturated compound having at least two non-aromatic carbon-carbon double bonds, at least one carbon-carbon triple bond, or a combination thereof;
   c) from 0.01 to 8 weight percent of at least one quaternary ammonium or phosphonium salt;
   d) from 0.05 to 10 weight percent of at least one organic peroxide; and
   e) optionally from 0.01 to 10 weight percent of a photoinitiator system capable of generating free radicals upon exposure to actinic radiation (preferably at about 450 nm),
      wherein the curable sealant composition is free of polyepoxide, and
      wherein x and y are positive real numbers, wherein x+y is in the range of 72 to 99, and wherein the weight percent ranges of the components a)-e) are based on the total weight of the components a)-e);
ii) optionally exposing at least a portion of the at least one photoinitiator to actinic electromagnetic radiation; and
iii) curing the curable sealant composition throughout its bulk.

In a twenty-sixth embodiment, the present disclosure provides a method according to the twenty-fifth embodiment, wherein the curable sealant composition is free of an organoborane-amine complex.

In a twenty-seventh embodiment, the present disclosure provides a method according to the twenty-fifth or twenty-sixth embodiment, further comprising at least one of an adhesion promoter or a wetting agent.

In a twenty-eighth embodiment, the present disclosure provides a method according to any one of the twenty-fifth to twenty-seventh embodiments, wherein the adhesion promoter comprises a coupling agent.

In a twenty-ninth embodiment, the present disclosure provides a method according to any one of the twenty-fifth to twenty-eighth embodiments, wherein the substrate comprises an aircraft component.

In a thirtieth embodiment, the present disclosure provides a method according to any one of the twenty-fifth to twenty-ninth embodiments, wherein the curable sealant composition is applied to a seam or joint between portions of aircraft skin.

In a thirty-first embodiment, the present disclosure provides a method according to the thirtieth embodiment, wherein the curable sealant composition is applied to at least one of an aircraft fastener, an aircraft window, an aircraft access panel, a fuselage protrusion, or an aircraft fuel tank.

In a thirty-second embodiment, the present disclosure provides a seal cap comprising:

a cap which defines an interior that is open at one end; and

curable sealant composition disposed within the interior of the seal cap, wherein the curable sealant composition comprises components:
a) x weight percent of at least one polythiol;
b) y weight percent of at least one unsaturated compound having at least two non-aromatic carbon-carbon double bonds, at least one carbon-carbon triple bond, or a combination thereof;
c) from 0.01 to 8 weight percent of at least one quaternary ammonium or phosphonium salt;
d) from 0.05 to 10 weight percent of at least one organic peroxide; and
e) optionally from 0.01 to 10 weight percent of a photoinitiator system capable of generating free radicals upon exposure to actinic radiation (preferably at about 450 nm),
wherein the curable sealant composition is free of polyepoxide, and
wherein x and y are positive real numbers, wherein x+y is in the range of 72 to 99, and wherein the weight percent ranges of the components a)-e) are based on the total weight of the components a)-e).

In a thirty-third embodiment, the present disclosure provides a method according to the thirty-second embodiment, wherein the curable sealant composition is free of an organoborane-amine complex.

In a thirty-fourth embodiment, the present disclosure provides a method according to the twenty-third or twenty-fourth embodiment, wherein the Part A composition and the Part B composition collectively further comprise component:
f) from 0.01 to 8 weight percent of at least one β-dicarbonyl compound, wherein the weight percent is based on the total weight of the components a)-f).

In a thirty-fifth embodiment, the present disclosure provides a method according to any one of the twenty-fifth to thirty-first embodiments, wherein the curable composition further comprises component:
f) from 0.01 to 8 weight percent of at least one β-dicarbonyl compound, wherein the weight percent is based on the total weight of the components a)-f).

In a thirty-sixth embodiment, the present disclosure provides a seal cap according to the thirty-second or thirty-third embodiment, wherein the curable composition further comprises component:
f) from 0.01 to 8 weight percent of at least one β-dicarbonyl compound, wherein the weight percent is based on the total weight of the components a)-f).

Objects and advantages of this disclosure are further illustrated by the following non-limiting examples, but the particular materials and amounts thereof recited in these examples, as well as other conditions and details, should not be construed to unduly limit this disclosure.

### EXAMPLES

Unless otherwise noted, all parts, percentages, ratios, etc. in the Examples and the rest of the specification are by weight.

Designations and materials used in the Examples are reported in Table 1, below.

TABLE I

| DESIGNATION | MATERIAL |
|---|---|
| AC-X92 | thiol-terminated polythioether oligomer with the equivalent weight of |
| | 1454 grams/—SH equivalent |
| BPBA | 1-benzyl-5-phenyl barbituric acid, obtained from PCM Products, |
| | Krefeld, Germany |
| BTAC | benzyltributylammonium chloride, obtained from Alfa Aesar, Ward |
| | Hill, Massachusetts |
| BTC | benzethonium chloride, obtained from Alfa Aesar |
| CHP | cumene hydroperoxide, technical grade, obtained from Alfa Aesar |
| DAEBPA | diallyl ether of bisphenol A, obtained from Bimax, Glen Rock, |
| | Pennsylvania |
| DMBA | 1,3-dimethylbarbituric acid, obtained from Alfa Aesar |
| DVE | triethylene glycol divinyl ether, obtained from BASF Chemical Co., |
| | Ludwigshafen, Germany |
| IBA | isobutyl barbituric acid, obtained from Sigma-Aldrich, St. Louis, |
| | Missouri |
| MCHD | 2-methyl-1,3-cyclohexanedione, obtained from Alfa Aesar |
| MCPD | 2-methyl-1,3-cyclopentanedione, obtained from Alfa Aesar |
| OR819 | Phenylbis(2,4,6-trimethylbenzoyl)phosphine oxide obtained under the |
| | trade designation OMNIRAD 819 from IGM resins, St. Charles, |
| | Illinois |
| SoCal 322 | coated calcium carbonate obtained from Solvay Chemicals, Houston, |
| | Texas |
| TAIC | triallyl isocyanurate, obtained from Tokyo Chemical Industry Co., |
| | Portland, Oregon |
| TBAA | tetrabutylammonium acetate, obtained from Alfa Aesar |
| TBEC | tert-butylperoxy 2-ethylhexyl carbonate, obtained from Sigma-Aldrich |
| TBPB | tetrabutylphosphonium bromide, obtained from Alfa Aesar |
| TBPIN | tert-butylperoxy-3,5,5-trimethylhexanoate, obtained as Trigonox 42S |
| | from AkzoNobel, Chicago, Illinois |
| TMPTMP | trimethylolpropane tris(3-mercaptopropionate), obtained from Tokyo |
| | Chemical Industry Co. |
| TOAB | tetraoctylammonium bromide, obtained from Alfa Aesar |
| UPF | Ultra-Pflex, obtained from Specialty Materials, Inc., Bethlehem, |
| | Pennsylvania |

### Test Methods

In Tables 2-4 and 6-8: “open time” refers to the approximate amount of time that the formulation exhibits sufficient flow such that it can still be manually spread and would be expected to completely wet out a surface to which it is applied; and

“tack-free time” was judged by removing the sample from the mixing cup and pressing firmly on it with a finger while wearing a nitrile glove. If any of the sample material stuck to the glove, the sample was judged to still be tacky. Once no material would stick to the glove, the sample was judged tack-free.

### Light Cure Conditions

Freshly mixed sealant was placed into an open-faced polytetrafluoroethylene (PTFE) mold with cavity dimensions of 3.75 inches×1.6 inches×0.125 inch (9.5 cm×4.1 cm×0.3 cm). The excess sealant was scraped off with a flat-bladed scraper. The sample was then placed under an AW-240-455F-7 blue LED array (455 nm) attached to a CT-2000 UV-Vis LED power source from Clearstone Technologies, Inc. (Hopkins, Minn.) and irradiated at 100% power for 30 seconds. The nominal distance between the light array and the sealant surface was 1 inch (2.54 cm).

### Hardness Measurements

The instantaneous Shore A hardness was determined using a Type A Model 2000 Durometer from Rex Gauge Company (Buffalo Grove, Ill.) after the sealant was allowed to cure under the given conditions. The reading was taken on two 0.125 inch (3.2 mm) thick specimens, stacked front to front.

### Examples 1 to 5 and Comparative Example A

Examples 1-5 demonstrate the accelerative effect that is observed upon addition of various onium salt in the curing of thiol-ene resin formulations containing TBEC peroxide. Samples were prepared by adding the thiol (TMPTMP, 1.33 grams) and quaternary onium salt (if any) together in a 10 g mixing cup and mixing at 2000 revolutions per minute (rpm) for 2 minutes. This mixture was allowed to sit overnight and was then mixed at 2000 rpm for an additional 2 minutes. The ene (DAEBPA, 1.54 grams) and TBEC (0.15 grams) components were then added, and the mixture was mixed at 1500 rpms for 1 minute. Each example thus contained 3.34 mmol TMPTMP, 5.00 mmol DAEBPA, and 0.61 mmol TBEC. The amount of quaternary ammonium salt incorporated to this base formulation for each example below is report in mmol in Table 2.

Comparative Example A does not contain any quaternary onium salt. Partial curing was observed, but after 72 hours it was still judged to be open. This material also never became fully tack-free.

Examples 1-5 contain a quaternary onium salt and exhibit significant cure acceleration. They also all became tack-free within 54 hours.

TABLE 2

| | | | | | | | Tack-free |
|---|---|---|---|---|---|---|---|
| | BTC, | TBAA, | TBPB, | TOAB, | BTAC, | Open time, | time, |
| EXAMPLE | mmol | mmol | mmol | mmol | mmol | hours:minutes | hours |
| Comp. Ex. A | — | — | — | — | — | >72:00 | — |
| 1 | 0.05 | — | — | — | — | 2:20 | 10 |
| 2 | — | 0.05 | — | — | — | 2:50 | 48 |
| 3 | — | — | 0.05 | — | — | 4:00 | 18 |
| 4 | — | — | — | 0.05 | — | 1:20 | 54 |
| 5 | — | — | — | — | 0.05 | 5:00 | 26 |

### Examples 6 to 10 and Comparative Example B

Examples 6-10 in Table 3 demonstrate the accelerative effect that is observed upon addition of various quaternary ammonium salts in the curing of thiol-ene resin formulations containing TBPIN peroxide. Samples were prepared by adding the thiol (TMPTMP, 1.33 grams) and quaternary onium salt (if any) together in a 10 g mixing cup and mixing at 2000 rpm for 2 minutes. This mixture was allowed to sit overnight and was then mixed at 2000 rpm for an additional 2 minutes. The ene (DAEBPA, 1.54 grams) and TBPIN (0.20 gram) components were then added, and the mixture was mixed at 1500 rpms for 1 minute. Each example thus contained 3.34 mmol TMPTMP, 5.00 mmol DAEBPA, and 0.87 mmol TBPIN. The amount of quaternary onium salt incorporated to this base formulation for each example below is reported in mmol.

Table 3 reports the curing behavior of Examples 6-10 and Comparative Example B. Open time refers to the approximate amount of time that the formulation exhibits sufficient flow such that it can still be manually spread and would be expected to completely wet out a surface to which it is applied. Tack-free time is judged by removing the sample from the DAC cup and pressing firmly on it with a finger while wearing a nitrile glove. If any of the sample material sticks to the glove, the sample is judged to still be tacky. Once no material would stick to the glove, the sample was judged tack-free.

Comparative Example B does not contain any quaternary onium salt. Partial curing was observed, but after 72 hours it was still judged to be open. This material also never became fully tack-free.

Examples 6-10 contain a quaternary onium salt, with most exhibiting significant cure acceleration and becoming tack-free within 48 hours. Example 8, containing TBAA, showed only slight acceleration and never fully became tack-free.

TABLE 3

| | | | | | | | Tack-free |
|---|---|---|---|---|---|---|---|
| | BTC, | TBAA, | TBPB, | TOAB, | BTAC, | Open time, | time, |
| EXAMPLE | mmol | mmol | mmol | mmol | mmol | hours:minutes | hours |
| Comp. Ex. B | — | — | — | — | — | >72:00 | — |
| 6 | 0.05 | — | — | — | — | 1:00 | 18 |
| 7 | — | 0.05 | — | — | — | 72 | n/a |
| 8 | — | — | 0.05 | — | — | 5:00 | 48 |
| 9 | — | — | — | 0.05 | — | 0:40 | 5 |
| 10 | — | — | — | — | 0.05 | 6:00 | 26 |

### Examples 11 to 15 and Comparative Example C

Examples 11-15 and Comparative Example C demonstrate the accelerative effect that is observed upon addition of various quaternary ammonium salts in the curing of thiol-ene resin formulations containing CHP hydroperoxide. Samples were prepared by adding the thiol (TMPTMP, 1.33 grams) and quaternary ammonium salt (if any) together in a 10 g mixing cup and mixing at 2000 rpms for 2 minutes. This mixture was allowed to sit overnight and was then mixed at 2000 rpms for an additional 2 minutes. The ene (DAEBPA, 1.54 grams) and CHP (0.15 grams) components were then added, and the mixture was mixed at 1500 rpms for 1 minute. Each example thus contains 3.34 mmol TMPTMP, 5.00 mmol DAEBPA, and 0.79 mmol CHP. The amount of quaternary ammonium salt incorporated to this base formulation for each example below is reported in Table 4 in mmol.

Comparative Example C does not contain any quaternary ammonium salt. Partial curing was observed, but after 72 hours it was still judged to be open. This material also never became fully tack-free. Examples 11-15 contain a quaternary onium salt and all exhibited significant cure acceleration. They all also became tack-free within 48 hours.

TABLE 4

| | | | | | | | Tack-free |
|---|---|---|---|---|---|---|---|
| | BTC, | TBAA, | TBPB, | TOAB, | BTAC, | Open time, | time, |
| EXAMPLE | mmol | mmol | mmol | mmol | mmol | hours:minutes | hours |
| Comp. Ex. C | — | — | — | — | — | >72:00 | — |
| 11 | 0.05 | — | — | — | — | 0:05 | 3 |
| 12 | — | 0.05 | — | — | — | 0:10 | 48 |
| 13 | — | — | 0.05 | — | — | 0:20 | 8 |
| 14 | — | — | — | 0.05 | — | 0:05 | 3 |
| 15 | — | — | — | — | 0.05 | 0:10 | 3 |

### Examples 16 to 20 and Comparative Examples D and E

Examples 16-20 and Comparative Examples D and E demonstrate the accelerative effect that is observed upon addition of the quaternary ammonium salt BTAC in curing a filled thiol-ene sealant formulation. These examples also demonstrate how the incorporation of a β-dicarbonyl component (in this case BPBA) can lengthen open time while simultaneously reducing the time to become tack-free.

Stock solutions of the BPBA and BTAC reagents in thiol were prepared as follows. Stock Solution 1 (SS1) was prepared by adding BPBA (0.20 grams) to AC-X92 (12.00 grams) in a 20 g mixing cup, and the mixture was mixed at 2000 rpms for 2 minutes. This mixture was allowed to sit overnight and was then mixed at 2000 rpms for an additional 2 minutes. Similarly, Stock solution 2 (SS2) Was prepared by adding BTAC (0.20 grams) to AC-X92 (12.00 grams) in a 20 g mixing cup, and the mixture was mixed at 2000 rpms for 2 minutes. This mixture was allowed to sit overnight and was then mixed at 2000 rpms for an additional 2 minutes. A stock solution of the ene components (SS3) was prepared as follows. DAEBPA (12.45 grams) and TAIC (2.55 grams) were placed together in a 20 g mixing cup and mixed at 2000 rpm for 3 minutes.

Examples 16-22 were then prepared by combining AC-X92 thiol, the stock solutions, UPF filler, and TBEC as reported in Table 5, below.

TABLE 5

| | grams | | | | | |
|---|---|---|---|---|---|---|
| EXAMPLE | AC-X92 | SS1 | SS2 | SS3 | UPF | TBEC |
| Comp. Ex. D | 3.00 | — | — | 0.25 | 1.65 | 0.10 |
| Comp. Ex. E | 1.50 | 1.50 | — | 0.25 | 1.65 | 0.10 |
| 16 | 1.50 | — | 1.50 | 0.25 | 1.65 | 0.10 |
| 17 | 1.125 | 1.50 | 0.375 | 0.25 | 1.65 | 0.10 |
| 18 | 0.75 | 1.50 | 0.75 | 0.25 | 1.65 | 0.10 |
| 19 | 0.375 | 1.50 | 1.125 | 0.25 | 1.65 | 0.10 |
| 20 | — | 1.50 | 1.50 | 0.25 | 1.65 | 0.10 |

Table 6 reports the millimoles of BPBA and BTAC in each of Comparative Examples D-E and Examples 16-20, along with their curing behavior.

Comparative Examples D and E are comparative formulations which do not contain any BTAC. These samples were very slow to cure, remaining open after 24 hours. They also did not become tack-free. Example 17 also incorporates BPBA to demonstrate that this additive by itself does not appear to aid the thiol-ene cure during this time frame. Example 16 incorporates BTAC, which again demonstrates the ability of this quaternary ammonium salt to accelerate both the cure and time to a tack-free state. Examples 17-20 contain both BPBA and BTAC, demonstrating that combinations of these materials can be useful in controlling open time and tack-free time. Examples 19 and 20 are particularly notable, as these combinations of BPBA and BTAC allowed an extension of open time with simultaneous reduction in tack-free time, relative to Example 16 which incorporated only BTAC.

TABLE 6

| | | | OPEN | TACK-FREE |
|---|---|---|---|---|
| | BPBA, | BTC, | TIME, | TIME, |
| EXAMPLE | mmol | mmol | hours | hours |
| Comp. Ex. D | — | — | >24 | — |
| Comp. Ex. E | 0.082 | — | >24 | — |
| 16 | — | 0.078 | 1:30 | 24 |
| 17 | 0.082 | 0.020 | 24 | n/a |
| 18 | 0.082 | 0.039 | 18 | 48 |
| 19 | 0.082 | 0.059 | 4 | 20 |
| 20 | 0.082 | 0.078 | 2.5 | 16 |

### Examples 21-26

Examples 21-26 demonstrate a variety of O-dicarbonyl compound additives that can be utilized to reduce time to tack-free state in the curing of sealant formulations.

Stock solutions of the β-dicarbonyl compound additives in ene components were prepared as follows. DAEBPA (12.45 grams) and TAIC (2.55 grams) were placed together in a 20 g mixing cup and mixed at 2000 rpm for 3 minutes. For each of the β-dicarbonyl compound compounds, 0.45 mmol of the β-dicarbonyl compound was placed in a 10 g mixing cup with 2.00 grams of the ene mixture. The resultant mixture was mixed at 2000 rpm for 2 minutes, then allowed to sit overnight, then mixed again at 2000 rpm for 2 minutes.

A stock solution of the thiol and quaternary ammonium salt BTAC was prepared as follows. AC-X92 (100.0 grams) and BTAC (0.52 grams) were placed in a glass jar. A magnetic stirbar was added, and the mixture was stirred for several days to ensure complete dissolution of the BTAC. A 60.0 gram portion of this mixture was placed in a 100 g mixing cup, and SoCal 322 filler (33.0 grams) was added. The resultant mixture was mixed 3 times, each for 2 minutes at 2000 rpm.

Each of the examples 21-26 were then prepared by placing 4.65 grams of the thiol/BTAC stock solution and 0.25 grams each of the β-dicarbonyl/ene stock solutions in a 10 g mixing cup and mixing at 2000 rpm for 1 minute. To each mixing cup was then added 0.10 grams of TBEC, and this mixture was hand stirred for approximately 1 minute. Each of these samples thus contains 2.06 mmol thiol functionality, 1.86 mmol ene functionality, 0.050 mmol BTAC, and 0.056 mmol of the corresponding 13-dicarbonyl compound additive.

Table 7 reports the curing behavior of Examples 21-26. Example 21 contains no β-dicarbonyl compound additive and provides a baseline for the length of time required to reach a tack-free state. Examples 22 and 23 incorporate β-diketones, which have little impact on the open time of these formulations but significantly reduce the time to tack-free state. Examples 24-27 incorporate barbituric acid derivatives, which in this case reduce both the open time and time to tack-free state.

TABLE 7

| | | | | | | | OPEN | TACK-FREE |
|---|---|---|---|---|---|---|---|---|
| | BTAC, | MCPD, | MCDH, | IBA, | DMBA, | BPBA, | TIME, | TIME, |
| EXAMPLE | mmol | mmol | mmol | mmol | mmol | mmol | hours | hours |
| 21 | 0.050 | — | — | — | — | — | 3:30 | 96 |
| 22 | 0.050 | 0.056 | — | — | — | — | 3:15 | 26 |
| 23 | 0.050 | — | 0.056 | — | — | — | 3:30 | 34 |
| 24 | 0.050 | — | — | 0.056 | — | — | 1:50 | 26 |
| 25 | 0.050 | — | — | — | 0.056 | — | 2:05 | 34 |
| 26 | 0.050 | — | — | — | — | 0.056 | 1:50 | 34 |

Examples 27-32 demonstrate sealant formulations which contain a photoinitiator system, and thus can optionally be cured by exposure to actinic radiation.

For Comparative Examples F and G, a stock solution of the ene components was prepared by placing DAEBPA (7.47 grams (g)) and TAIC (1.53 grams) together in a 20 g mixing cup and mixing at 2000 rpm for 3 minutes.

Comparative Example F was prepared by placing AC-X92 (30.0 grams) and SoCal 322 filler (16.5 grams) together in a 100 g mixing cup and mixing at 2000 rpm for 3 minutes. The ene stock solution (2.5 grams) and TBEC (1.0 gram) were then added, followed by mixing at 2000 rpm for 30 seconds.

A stock solution of the thiol and quaternary ammonium salt BTAC was prepared as follows. AC-X92 (300.0 grams) and BTAC (1.56 grams) were placed in a glass jar. A magnetic stirbar was added, and the mixture was stirred for several days to ensure complete dissolution of the BTAC.

Comparative Example G was prepared by placing 30.0 grams of the thiol/BTAC stock solution and 16.5 grams of the SoCal 322 filler in a 100 g mixing cup and mixing at 2000 rpm for 3 minutes. The ene stock solution (2.5 grams) and TBEC (1.0 gram) were then added, followed by mixing at 2000 rpm for 30 seconds.

A stock solution of the ene components and OR819 was prepared by placing DAEBPA (24.90 grams), TAIC (5.10 grams), and OR819 (3.00 grams) together in a 40 g mixing cup and mixing at 2000 rpm for 3 minutes. The mixing cup was then placed in a 60 degree C. water bath for approximately 1 hour to ensure complete dissolution of the OR819.

Stock solutions of the β-dicarbonyl compound additives in ene/OR819 solutions were prepared by adding 0.675 mmol of the appropriate β-dicarbonyl compound in a 10 g mixing cup with 3.30 grams of the ene/OR819 stock solution. The resultant mixture was mixed at 2000 rpm for 2 minutes, then allowed to sit overnight, then mixed again at 2000 rpm for 2 minutes.

Examples 27-32 were then prepared by placing 30.0 grams of the thiol/BTAC stock solution and 16.5 grams of the SoCal 322 filler in a 100 g mixing cup and mixing at 2000 rpm for 3 minutes. Each of the appropriate β-dicarbonyl/ene/OR819 stock solutions (2.75 grams) and TBEC (1.0 gram) were then added, followed by mixing at 2000 rpm for 30 seconds.

Table 8 reports the time to cure and time to reach a tack-free state without exposure to actinic radiation for Comparative Examples F and G and Examples 27-32. Comparative Example F contains no quaternary ammonium salt and provides a baseline for the curing time necessary without this type of additive. Comparative Example G contains the quaternary ammonium salt BTAC, which demonstrates the accelerative impact of this additive and provides a baseline for the curing time necessary without the presence of any β-dicarbonyl or photoinitiator. Example 27 incorporates the quaternary ammonium salt BTAC and the photoinitiator OR819, and when compared to Comparative Example G demonstrates that OR819 does not have a significant impact on the cure in the absence of actinic radiation. Examples 28 and 29 incorporate β-diketones, which have little impact on the open time of these formulations but significantly reduce the time to tack-free state. Examples 30-32 incorporate barbituric acid derivatives, which in this case reduce both the open time and time to tack-free state.

TABLE 8

| | | | | | | | | OPEN | TACK-FREE |
|---|---|---|---|---|---|---|---|---|---|
| | OR819, | BTAC, | MCPD, | MCDH, | IBA, | DMBA, | BPBA, | TIME, | TIME, |
| EXAMPLE | mmol | mmol | mmol | mmol | mmol | mmol | mmol | hours | hours |
| COMP. EX. F | — | — | — | — | — | — | — | 26 | >46 |
| COMP. EX. G | — | 0.50 | — | — | — | — | — | 2:35 | >46 |
| 27 | 0.60 | 0.50 | — | — | — | — | — | 2:35 | >46 |
| 28 | 0.60 | 0.50 | 0.56 | — | — | — | — | 2:20 | 30 |
| 29 | 0.60 | 0.50 | — | 0.56 | — | — | — | 2:25 | 30 |
| 30 | 0.60 | 0.50 | — | — | 0.56 | — | — | 1:40 | 22 |
| 31 | 0.60 | 0.50 | — | — | — | 0.56 | — | 1:10 | 30 |
| 32 | 0.60 | 0.50 | — | — | — | — | 0.56 | 1:10 | 22 |

Table 9, below, reports the Shore A hardness build for Comparative Examples F and G and Examples 27-32, when not exposed to actinic radiation.

TABLE 9

| | SHORE A HARDNESS, | | | |
|---|---|---|---|---|
| | time after mixing with no irradiation | | | |
| EXAMPLE | 6 hours | 22 hours | 30 hours | 46 hours |
| COMPARATIVE | n/a | n/a | n/a | n/a |
| EXAMPLE F | | | | |
| COMPARATIVE | n/a | 13 | 23 | 27 |
| EXAMPLE G | | | | |
| 27 | n/a | 14 | 23 | 26 |
| 28 | n/a | 13 | 21 | 31 |
| 29 | n/a | 12 | 25 | 30 |
| 30 | n/a | 20 | 33 | 40 |
| 31 | n/a | 22 | 27 | 35 |
| 32 | 30 | 45 | 49 | 52 |

In Table 9, above, n/a means that the sample did not have sufficient hardness to measure with durometer

Table 10 reports the Shore A hardness build for Comparative Examples F and G and Examples 27-32 following irradiation as described in the Test Methods section. As Comparative Examples F and G contain no photoinitiator, irradiation has no significant impact on curing time or time to reach a tack-free state relative to samples which were not irradiated. Examples 27-32, which do contain photoinitiator, are immediately cured to a tack-free state with a high level of Shore A hardness.

TABLE 10

| | SHORE A HARDNESS, | | | | |
|---|---|---|---|---|---|
| | time after mixing and light cure | | | | |
| EXAMPLE | 0 hours | 6 hours | 22 hours | 30 hours | 46 hours |
| COMPARATIVE | n/a | n/a | n/a | n/a | n/a |
| EXAMPLE F | | | | | |
| COMPARATIVE | n/a | n/a | 12 | 25 | 29 |
| EXAMPLE G | | | | | |
| 27 | 43 | 46 | 50 | 52 | 54 |
| 28 | 40 | 45 | 49 | 50 | 51 |
| 29 | 42 | 44 | 48 | 50 | 53 |
| 30 | 38 | 42 | 50 | 52 | 53 |
| 31 | 15 | 26 | 35 | 42 | 43 |
| 32 | 43 | 52 | 54 | 56 | 58 |

In Table 10, above, n/a means that the sample did not have sufficient hardness to measure with durometer.

All cited references, patents, and patent applications in the above application for letters patent are herein incorporated by reference in their entirety in a consistent manner. In the event of inconsistencies or contradictions between portions of the incorporated references and this application, the information in the preceding description shall control. The preceding description, given in order to enable one of ordinary skill in the art to practice the claimed disclosure, is not to be construed as limiting the scope of the disclosure, which is defined by the claims and all equivalents thereto.

1. A curable sealant composition comprising components:
a) x weight percent of at least one polythiol;
b) y weight percent of at least one unsaturated compound having at least two non-aromatic carbon-carbon double bonds, at least one carbon-carbon triple bond, or a combination thereof;
c) from 0.01 to 8 weight percent of at least one quaternary ammonium or phosphonium salt represented by the formula
(R¹¹)₄M⁺X⁻
wherein
each R¹¹ independently represents a hydrocarbyl group having from 1 to 30 carbon atoms;
M⁺ represents N⁺ or P⁺; and
X⁻ represents an anion that is not detrimental to curing of the curable sealant composition;
d) from 0.05 to 10 weight percent of at least one organic peroxide; and
e) optionally from 0.01 to 10 weight percent of a photoinitiator system capable of generating free radicals upon exposure to actinic electromagnetic radiation,
wherein the curable sealant composition is free of a polyepoxide and an organoborane-amine complex, and
wherein x and y are positive real numbers, wherein x+y is in the range of 72 to 99, and wherein the weight percent ranges of the components a)-e) are based on the total weight of the components a)-e).

2. The curable sealant composition of claim 1, further wherein the curable sealant composition is free of an organoborane-amine complex.

3. The curable sealant composition of claim 1, wherein the curable sealant composition comprises:
a) from 70 to 98 weight percent of the at least one polythiol;
b) from 2 to 20 weight percent of the at least one unsaturated compound;
c) from 0.01 to 8 weight percent of the at least one quaternary ammonium or phosphonium salt;
d) from 0.05 to 10 weight percent of the at least one organic peroxide; and
e) optionally from 0.01 to 10 weight percent of the photoinitiator system capable of generating free radicals upon exposure to actinic radiation.

4. The curable sealant composition of claim 1, wherein the curable sealant composition comprises:
a) from 80 to 95 weight percent of the at least one polythiol;
b) from 3 to 10 weight percent of the at least one unsaturated compound;
c) from 0.25 to 3 weight percent of the at least one quaternary ammonium or phosphonium salt;
d) from 0.75 to 5 weight percent of the at least one organic peroxide; and
e) optionally from 0.1 to 1.5 weight percent of the photoinitiator system capable of generating free radicals upon exposure to actinic radiation.

5. The curable sealant composition of claim 1, further comprising at least one of an adhesion promoter or a wetting agent.

6. The curable sealant composition of claim 1, wherein the at least one polythiol comprises an aliphatic polythiol.

7. The curable sealant composition of claim 1, wherein the at least one unsaturated compound comprises a compound having at least two vinyl groups.

8. The curable sealant composition of claim 1, wherein the quaternary ammonium salt and the quaternary phosphonium salt are represented by the formula (R¹¹)₄M⁺X⁻, wherein:
M represents N or P;
each R¹¹ independently represents a hydrocarbyl group having from 1 to 22 carbon atoms; and
X represents Cl, Br, or acetate.

9. The curable sealant composition of claim 1, wherein component e) is present.

10. The curable sealant composition of claim 9, wherein the photoinitiator system comprises an acylphosphine oxide.

11. The curable sealant composition of claim 1, further comprising component:
f) from 0.01 to 8 weight percent of at least one β-dicarbonyl compound, wherein the weight percent is based on the total weight of the components a)-f).

12. A two-part curable sealant composition comprising a Part A composition and a Part B composition, wherein:
the Part A composition comprises at least one polythiol; and
the Part B composition comprises at least one unsaturated compound having at least two non-aromatic carbon-carbon double bonds, at least one carbon-carbon triple bond, or a combination thereof, wherein the Part A composition and the Part B composition collectively comprise components:
a) x weight percent of at least one polythiol;
b) y weight percent of at least one unsaturated compound having at least two non-aromatic carbon-carbon double bonds, at least one carbon-carbon triple bond, or a combination thereof;
c) from 0.01 to 8 weight percent of at least one quaternary ammonium or phosphonium salt represented by the formula
(R¹¹)₄M⁺X⁻
wherein
each R¹¹ independently represents a hydrocarbyl group having from 1 to 30 carbon atoms;
M⁺ represents N⁺ or P⁺; and
X⁻ represents an anion that is not detrimental to curing of the curable sealant composition;
d) from 0.05 to 10 weight percent of at least one organic peroxide; and
e) optionally from 0.01 to 10 weight percent of a photoinitiator system capable of generating free radicals upon exposure to actinic electromagnetic radiation,
wherein the two-part curable sealant composition is free of a polyepoxide, and
wherein x and y are positive real numbers, wherein x+y is in the range of 72 to 99, and wherein the weight percent ranges of the components a)-e) are based on the total weight of the components a)-e).

13. The two-part curable sealant composition of claim 12, further wherein the two-part curable sealant composition is free of an organoborane-amine complex.

14. The two-part curable sealant composition of claim 12, wherein the components comprise:
a) from 70 to 98 weight percent of the at least one polythiol;
b) from 2 to 20 weight percent of the at least one unsaturated compound;
c) from 0.01 to 8 weight percent of the at least one quaternary ammonium or phosphonium salt;
d) from 0.05 to 10 weight percent of the at least one organic peroxide; and
e) optionally from 0.01 to 10 weight percent of the photoinitiator system capable of generating free radicals upon exposure to actinic radiation.

15. The two-part curable sealant composition of claim 12, wherein the components comprise:
a) from 80 to 95 weight percent of the at least one polythiol;
b) from 3 to 10 weight percent of the at least one unsaturated compound;
c) from 0.25 to 3 weight percent of the at least one quaternary ammonium or phosphonium salt;
d) from 0.75 to 5 weight percent of the at least one organic peroxide; and
e) optionally from 0.1 to 1.5 weight percent of the photoinitiator system capable of generating free radicals upon exposure to actinic radiation.

16. (canceled)

17. The two-part curable sealant composition of claim 12, wherein the at least one polythiol comprises an aliphatic polythiol.

18. The two-part curable sealant composition of claim 12, wherein the at least one unsaturated compound comprises a compound having at least two vinyl groups.

19. The two-part curable sealant composition of claim 12, wherein the quaternary ammonium salt and the quaternary phosphonium salt are represented by the formula (R¹¹)₄M⁺X⁻, wherein:
M represents N or P;
each R¹¹ independently represents a hydrocarbyl group having from 1 to 22 carbon atoms; and
X represents Cl, Br, or acetate.

20. The two-part curable sealant composition of claim 12, wherein component e) is present.

21. The two-part curable sealant composition of claim 12, wherein the at least one photoinitiator comprises an acylphosphine oxide.

22. The two-part curable sealant composition of claim 12, further comprising component:
f) from 0.01 to 8 weight percent of at least one β-dicarbonyl compound, wherein the weight percent is based on the total weight of the components a)-f).

23. (canceled)

24. (canceled)

25. (canceled)

26. (canceled)

27. (canceled)

28. (canceled)

29. (canceled)

30. (canceled)

31. (canceled)

32. A seal cap comprising:
a cap which defines an interior that is open at one end; and
curable sealant composition disposed within the interior of the seal cap, wherein the curable sealant composition comprises components:
a) x weight percent of at least one polythiol;
b) y weight percent of at least one unsaturated compound having at least two non-aromatic carbon-carbon double bonds, at least one carbon-carbon triple bond, or a combination thereof;
c) from 0.01 to 8 weight percent of at least one quaternary ammonium or phosphonium salt represented by the formula
(R¹¹)₄M⁺X⁻
wherein
each R¹¹ independently represents a hydrocarbyl group having from 1 to 30 carbon atoms;
M⁺ represents N⁺ or P⁺; and
X⁻ represents an anion that is not detrimental to curing of the curable sealant composition;
d) from 0.05 to 10 weight percent of at least one organic peroxide; and
e) optionally from 0.01 to 10 weight percent of a photoinitiator system capable of generating free radicals upon exposure to actinic radiation,
wherein the curable sealant composition is free of polyepoxide, and
wherein x and y are positive real numbers, wherein x+y is in the range of 72 to 99, and wherein the weight percent ranges of the components a)-e) are based on the total weight of the components a)-e).

33. (canceled)
